(19) United States
(12) Patent Application Publication
(10) Pub. No.: US 2011/0119350 A1
(43) Pub. Date: May 19, 2011

(54) DATA MANAGEMENT METHOD AND SYSTEM, AND APPARATUS USED THEREIN

(75) Inventor: Keiichi KOSHIBA, Tokyo (JP)

(73) Assignee: PANASONIC CORPORATION, Osaka (JP)

(21) Appl. No.: 13/011,464

(22) Filed: Jan. 21, 2011

Related U.S. Application Data
(63) Continuation of application No. 09/610,107, filed on Jul. 5, 2000.

(30) Foreign Application Priority Data
Jul. 7, 1999 (JP) 11-193783
Mar. 15, 2000 (JP) 2000-71847

(51) Int. Cl. G06F 15/16

(52) U.S. Cl. 709/217

(57) ABSTRACT

An information unit carries information representing an item in base information provided unidirectionally to an information recipient from an information provider. The unit is part of the base information. A first communications device generates an information recipient verification data for an information recipient and an identifying data for the unit selected by the recipient. An information manager receives the verification data and the identifying data from the first device. The identifying data and the verification data are stored and linked in a first database. The identifying data and a reference data are stored and linked in a second database. The reference data defines features of the corresponding unit. Another communications device forwards the verification data to the information manager to access the first database and find the identifying data, and the first database accesses the second database to obtain the reference data, whereby the other can receive the reference data.

### CROSS REFERENCE TO RELATED APPLICATIONS

The present application is a Continuation of U.S. Patent Application No. 09/610,107 filed on Jul. 5, 2000, which claims priority of Japanese Application No. 11-193783 filed on Jul. 7, 1999 and Japanese Application No. 2000-71847 filed on Mar. 15, 2000, the contents of which are expressly incorporated by reference herein in their entireties.

### BACKGROUND OF THE INVENTION

1. Field of the Invention

This invention relates to a data management method and apparatus, and to a data management system wherein those are used, and more particularly to a data management method or system wherein, of various kinds of information introduced by television broadcasts, magazines, or catalogs, etc., that information which a viewer, magazine subscriber, or other information recipient is interested in is subjected to simple data management, and wherewith the information recipient can call up reference data at any time using a communication terminal.

2. Description of the Related Art

In recent years, due to developments in communications technology and data processing technology, multimedia information such as audio information and visual information is being digitized and provided to users. Thus various kinds of information are being sent out using broadcast and communications facilities, and received, sometimes stored, and viewed with receiving terminals of users, that is, of information recipients. Conditions are becoming such that broadcast systems supporting such operations are possible. The same sorts of various kinds of information are also increasingly being provided to information recipients by printed media such as magazines or catalogs, or by other mass media, not limited to the broadcasts described above.

With respect to techniques for providing such various kinds of information, in terms of schemes already being implemented, in television broadcasting, various kinds of program service content data (various kinds of information, that is, contents) that are configured by video information and audio information and transmitted by broadcast means, and information (additional information) such as reference data relating to those various kinds of information prepared additionally to those kinds of information, are produced. That information and reference data are broadcast as the various kinds of information noted above from centers, that is, from the information providing apparatus of information providers, and the various kinds of data including the reference data noted above that are broadcast are received and displayed by the information transceiving terminal equipment of the information recipients. In some cases, moreover, the various kinds of information including reference data that are broadcast are stored, and then, after a certain time has elapsed, that information is reproduced and displayed. Specific examples of the content of the reference data include menu displays, addresses, and telephone numbers, etc., for restaurants, or the places and times where events such as those put on by musical groups or the like will be held, together with ticket sales information therefor. The viewer looks at the reference data from these types of information displayed, and, if there are any introductions that attract his or her attention, he or she makes note of such data as the content thereof or telephone numbers therein in a pocket diary or the like for retention. Then the viewer can make inquiry or place an order on a later date using the information so noted. In cases where the reference data are printed matter such as magazines, the magazine subscriber who is the information recipient looks at the content noted and, if there is an introduction therein that attracts his or her notice, he or she notes such data as the content or telephone number in a pocket diary or the like for retention in the same manner as described above. Then he or she may make inquiry or place an order on a later data according to that noted information. In cases where coupons are included with the introductory data noted above, those coupons are cut out, placed in a purse, briefcase, or pocket, and used when there is an opportunity on a later date.

### PROBLEM TO BE SOLVED

As based on the methods for sending such information including reference data as practiced conventionally, and on the way in which viewers and the like handle such information, in cases where necessary items would be noted in a pocket diary, for example, they are often left is unnoted because of the trouble involved, or it sometimes happens that one will forget where the note was made. When coupons are placed in a purse or briefcase or the like, situations arise where they end up getting lost somehow. In addition, it is bothersome to carry various kinds of written guides (guidebooks and the like) about because they are heavy and inconvenient.

The present invention was devised in view of the problems noted above. A first object thereof is to enhance the convenience of users of various types of information introduced by television or radio broadcasts or by magazines, catalogs, pamphlets, and such like, by managing such information.

A second object of the present invention is to enhance the convenience of users of various types of information introduced in sample markets or various event venues by communications systems or broadcasts local to the venues.

A third object of the present invention is to make provision so that, of various kinds of information introduced by television broadcasts, magazines, or catalogs, etc., that information which a viewer, magazine subscriber, or other information recipient is interested in is subjected to simple data management, so that the information recipient can call up reference data at any time using a communication terminal.

### SUMMARY OF THE INVENTION

In order to attain the objects noted above, the present invention is configured so that various kinds of information including reference data that are configured by videos, audio, or text, etc., and sent by broadcast, are sent from an information provider to both an information recipient and an information manager, the various kinds of information sent to the information manager are stored and managed by the information manager, and data representing information selected by the information recipient from among the various kinds of information sent to the information recipient are sent to the information manager and registered by the information manager, whereupon the information recipient can call up the information manager using communications means, fetch the necessary reference data, and make use thereof.

The present invention has the following outstanding features.

According to the first aspect, a data management method comprises the steps of:

adding particular identifying data to each information unit in various kinds of information;

storing and managing, by an information management apparatus or other external device, said various kinds of information or information related thereto associated with said identifying data;

transmitting, when an information recipient selects information from among said various kinds of information, identifying data particular to that information to said information management apparatus by communications means;

registering and storing, by said information management apparatus or said external device when said information management apparatus receives said data, said identifying data in association with said information recipient; and

accessing and calling, by said information recipient, management information in said information management apparatus from a communications terminal,

whereby various kinds of information or information related thereto specified by said identifying data registered and stored in association with said information recipient are transmitted from said information management apparatus or said external device to said communications terminal.

According to the second aspect, a data management method comprises the steps of:

adding particular identifying data to each information unit in various kinds of information;

storing and managing, by an information management apparatus or other external device, said various kinds of information or information related thereto and associated with said identifying data;

transmitting, when an information recipient selects information from among said various kinds of information, identifying data particular to that information to said information management apparatus by communications means;

registering and storing, by said information management apparatus or said external device when said information management apparatus receives said data, various kinds of information or information related thereto specified by said identifying data, in association with said information recipient; and

accessing and calling, by said information recipient, management information in said information management apparatus from a communications terminal,

whereby various kinds of information or information related thereto registered and stored in association with said information recipient are transmitted from said information management apparatus to said communications terminal.

According to the third aspect, in the data management method according to either aspect 1 or 2, said various kinds of information are information that at least has video information, or audio information, or video information and audio information, or reference data for those kinds of information.

According to the fourth aspect, in the data management method according to either aspect 1 or 2, said various kinds of information are information printed in printed materials.

According to the fifth aspect, in the data management method according to either aspect 1 or aspect 2, said various kinds of information are information aired, broadcast, or disclosed at an event convention hall.

According to the sixth aspect, a data management method comprises the steps of:

sending reference data added information comprising various kinds of information having at least video information, or audio information, or video information and audio information, to which reference data which constitute detailed information for said various kinds of information have been added, from an information providing apparatus to an information receiving device by broadcast or other communications;

selecting by an information recipient, some information from said reference data added information sent to said information receiving device;

sending identifying data particular to said selected information to an information management apparatus, from said information receiving device, or from communications means that have received a signal from said information receiving device;

calling, by said information management apparatus, upon receiving said identifying data, reference data added information or reference data or related data related to reference data specified by said identifying data, from said information providing apparatus or from another external device;

registering and storing said data in association with said information recipient;

accessing and calling, by said information recipient, management information in said information management apparatus from a communications terminal,

whereby reference data added information or reference data or related data registered and stored in association with said information recipient are transmitted from said information management apparatus to said communications terminal.

According to the seventh aspect, a data management method comprises the steps of:

sending reference data added information comprising various kinds of information having at least video information, or audio information, or video information and audio information, to which reference data which constitutes detailed information for said various kinds of information have been added, from an information providing apparatus to an information receiving device by broadcast or other communications;

selecting by an information recipient, some information from said reference data added information sent to said information receiving device;

sending identifying data particular to said selected information to an information management apparatus, from said information receiving device, or from communications means that have received a signal from said information receiving device;

registering and storing, by said information management apparatus, upon receiving said identifying data, said identifying data in association with said information recipient;

accessing and calling, by said information recipient, management information in said information management apparatus from a communications terminal,

whereby identifying data particular to called information are transmitted from said information management apparatus to said information providing apparatus or other external device, reference data added information or reference data or reference data related to reference data specified by said identifying data are transmitted, either directly or via said information management apparatus, from said information providing apparatus or said external device, to said communications terminal.

According to the eighth aspect, a data management method comprises the steps of:

sending reference data added information comprising various kinds of information having at least video information, or audio information, or video information and audio information, to which reference data which constitutes detailed information for said various kinds of information have been added, from an information providing apparatus to an information receiving device by broadcast or other communications;

sending said reference data added information or reference data or related data related to reference data by broadcast or other is communications or prescribed presentation means from said information providing apparatus or other external device to an information management apparatus;

storing and managing said reference data added information or reference data or related data sent to said information management apparatus by said information management apparatus,

selecting, by an information recipient, some information from said reference data added information sent to said information receiving device;

sending identifying data particular to said selected information to said information management apparatus, from said information receiving device or, alternatively, from communications means that have received a signal from said information receiving device;

registering and storing, by said information management apparatus, upon receiving said identifying data, reference data added information or reference data or related data specified by said identifying data in association with said information recipient;

accessing and calling, by said information recipient, management information in said information management apparatus from a communications terminal,

whereby reference data added information or reference data or related data registered and stored in association with said information recipient are transmitted from said information management apparatus to said communications terminal.

According to the ninth aspect, a data management method comprises the steps of:

sending reference data added information comprising various kinds of information having at least video information, or audio information, or video information and audio information, to which reference data which constitutes detailed information for said various kinds of information have been added, from an information providing apparatus to an information receiving device by broadcast or other communications;

sending said reference data added information or reference data or related data related to reference data by broadcast or other communications or prescribed presentation means from said information providing apparatus or other external device to an information management apparatus;

storing and managing said reference data added information or reference data or related data sent to said information management apparatus by said information management apparatus;

selecting, by an information recipient, some information from said reference data added information sent to said information receiving device;

sending identifying data particular to said selected information to said information management apparatus, from said information receiving device or, alternatively, from communications means that have received a signal from said information receiving device;

registering and storing, by said information management apparatus, upon receiving said identifying data, said identifying data in association with said information recipient;

accessing and calling, by said information recipient, management information in said information management apparatus from a communications terminal,

whereby reference data added information or reference data or related data specified by said identifying data registered and stored in association with said information recipient, are transmitted from said information management apparatus to said communications terminal.

According to the tenth aspect, in the data management method according to any one of aspects 6 to 9, said identifying data contain at least (1) information indicating time selected by said information recipient, and (2) information indicating channel receiving information selected by said information recipient.

According to the eleventh aspect, in the data management method according to any one of aspects 6 to 9, said identifying data are particular codes added to each piece of said reference data or to each piece of said related data, prior to sending of said reference data added information from said information providing apparatus to said information receiving device.

According to the twelfth aspect, in the data management method according to any one of aspects 6 to 9, said information management apparatus,

when registering and storing identifying data or reference data added information or reference data or related data in association with said information recipient, also registers and stores either all or one or more types of information selected from among selected date indicating information, program indicating information, program genre indicating information, region indicating information, and sponsor indicating information; and,

when said information recipient accesses management information in said information management apparatus from a communications terminal, and calls out information, either said selected date indicating information, program indicating information, program genre indicating information, region indicating information, or sponsor indicating information is information-retrieved as a retrieval key.

According to the thirteenth aspect, in the data management method according to aspect 12, of retrieval keys consisting of two or more kinds of information out of said selected date indicating information, program indicating information, program genre indicating information, region indicating information, and sponsor indicating information, those are displayed on said communications terminal in order beginning with one selected with highest frequency in past.

According to the fourteenth aspect, the data management method according to aspect 12 or aspect 13, of retrieval keys comprising at least one kind of information out of said selected date indicating information, program indicating information, program genre indicating information, region indicating information, and sponsor indicating information, key words belonging to some retrieval key(s) are displayed on said communications terminal in order beginning with one selected with highest frequency in past.

According to the fifteenth aspect, an information providing apparatus used in the data management method cited in any one of aspects 6 to 9, comprises at least information production means for producing various kinds of information having at least video information or audio information, or video information and audio information, data editing means for adding reference data constituting detailed information for either some or all of said various kinds of information produced, and information transmission means for transmitting said various kinds of information to which said reference data have been added by broadcast or other communications.

According to the sixteenth aspect, the information providing apparatus according to aspect 15, further comprises mark addition means for adding a mark to said reference data added information to indicate that reference data have been added to that information.

According to the seventeenth aspect, the information providing apparatus according to aspect 15 or aspect 16, further comprises information sending means for associating said identifying data with said reference data added information or said reference data or said related data and sanding same to said information management apparatus by broadcast or other communications.

According to the eighteenth aspect, an information providing apparatus comprises:

information production means for producing various kinds of information having at least video information, or audio information, or video information and audio information;

data editing means for adding reference data constituting detailed information for either some or all of said various kinds of information produced to produce reference data added information;

information transmission means for adding particular identifying to data to said reference data added information and transmitting same to an information receiving device by broadcast or other communications; and

information sending means for associating said identifying data with said reference data added information or said reference data or related data related with said reference data and sending same to an information management apparatus by broadcast or other communications.

According to the nineteenth aspect, an information providing apparatus comprises:

information production means for producing various kinds of information having at least video information, or audio information, or video information and audio information;

data editing means for adding reference data constituting detailed information for either some or all of said various kinds of information produced to produce reference data added information;

identifying data addition means for adding particular identifying data to said reference data added information; and

information transmission means for transmitting said reference data added information by broadcast or other communications.

According to the twenties aspect, an information receiving device used in the data management method cited in any one of aspects 6 to 9, comprises:

information reception means for receiving reference data added information transmitted from said information providing apparatus;

display means for displaying received information;

designation signal reception means for receiving signals for designating information in cases where said information recipient has selected and designated some information from among said reference data added information; and

data sending means for sending identifying data particular to information selected and designated by said information recipient to said information management apparatus, either directly or through communications means.

According to the twenty-first aspect, the information receiving device according to aspect 20, further comprises memory means for storing said various kinds of information received, and playback means for reading and playing back said various kinds of information stored in said memory means, wherein information played back is displayed on said display means.

According to the twenty-second aspect, an information receiving device comprises:

information reception means for receiving reference data added information resulting from addition of reference data constituting detailed information for various kinds of information to said various kinds of information having at least video information or audio information or video information and audio information;

display means for displaying received information;

designation signal reception means for receiving signals for designating information in cases where said information recipient has selected and designated some information from among said reference data added information; and

data sending means for sending identifying data particular to information selected and designated by said information recipient to an information management apparatus, either directly or through communications means.

According to the twenty-third aspect, a remote controller that sends signals to an information receiving device that receives reference data added information resulting from addition of reference data constituting detailed information for various kinds of information to said various kinds of information having at least video information or audio information or video information and audio information and displays information so received, for selecting and designating certain information among said reference data added information, in response to control inputs of an information recipient, characterized in that, when an operation is performed on said remote controller for selecting and designating information, identifying data particular to said designated information are sent to an information management apparatus, either directly or via communications means.

According to the twenty-third aspect, the remote controller according to aspect 23, characterized in that said remote controller is a communication terminal having a designating signal sending function, and when a designating signal is sent to said information receiving device in response to control inputs from an information recipient, said identifying data are received from said information receiving device, and those identifying data are transmitted to said information management apparatus.

According to the twenty-fifth aspect, the remote controller according to aspect 23, characterized in that said remote controller is a communication terminal having a designating signal sending function, also having time information and information on channel currently being received, and identifying data specified by said time information and channel information are transmitted to said information management apparatus in response to control inputs of an information recipient.

According to the twenty-sixth aspect, the remote controller according to any one of aspects 23 to 25, characterized in that

said remote controller has a plurality of information designating buttons for separate individuals;

when any one of said plurality of information designating buttons is manipulated, said remote controller sends a signal for selecting and designating information to an information receiving device; and

said information receiving device transmits identifying data particular to said designated information to an information management apparatus, either directly or via communications means, associated with individual associated with said information designating button.

According to the twenty-seventh aspect, an information management apparatus used in the data management method cited in any of aspects 1 to 9, comprises:

read-out means for reading out information stored in memory means provided externally or internally;

identifying data reception means for receiving identifying data particular to information selected and designated by said information recipient;

data management means for registering and managing said identifying data or reference data added information or reference data or related data in association with said information recipient;

retrieval means for retrieving said identifying data or reference data to added information or reference data or related data registered and managed in association with said information recipient and called out by said information recipient accessing and calling from a communication terminal; and

data sending means for sending said identifying data or reference data added information or reference data or related data that have been retrieved by said retrieval means and read out by said read-out means.

According to the twenty-eighth aspect, an information management apparatus for managing reference data comprising detailed information for various kinds of information having at least video information, or audio information, or video information and audio information, or reference data added information resulting from adding reference data to said various kinds of information, or related data related to reference data, comprises:

read-out means for reading out information stored in memory means provided externally or internally;

identifying data reception means for receiving identifying data particular to information selected from among said various kinds of information, and designated, by an information recipient;

data management means for associating said identifying data or reference data added information or reference data or related data with said information recipient and registering and managing same;

retrieval means for retrieving said identifying data or reference data added information or reference data or related data registered and managed in association with said information recipient and called out by said information recipient accessing and calling from a communication terminal; and

data sending means for sending said identifying data or reference data added information or reference data or related data that have been retrieved by said retrieval means and read out by said read-out means.

According to the twenty-ninth aspect, a communications terminal used in the data management method cited in any one of aspects 1 to 9, comprises:

a control input unit for an information recipient to make control inputs with;

a transmitter for accessing said information management apparatus, based on control inputs from said control input unit, and transmitting signals for calling out registered information;

a receiver for receiving signals and data transmitted from said information management apparatus; and

a display unit for displaying received data.

According to the 30th aspect, the communications terminal according to aspect 29, that is a communications terminal for accessing said information management apparatus wherein information indicating region is also registered and stored, in cases where identifying data or reference data added information or reference data or related data are associated with an information recipient and registered and stored by said information management apparatus, wherein said communications terminal is also a navigation terminal or PHS, said region indicating information is compared with current position information resident in said navigation terminal or PHS, and, when both sets of information match or are close, said reference data added information or reference data or related data are displayed on said navigation terminal or PHS.

According to the 31st aspect, a data management system that is a data management system used in the data management method cited in any one of aspects 6 to 9, comprises:

an information providing apparatus,

an information receiving device, and

an information management apparatus:

said information providing apparatus comprising:
information production means for producing various kinds of information having at least video information, or audio information, or video information and audio information;
data editing means for adding reference data constituting detailed information for part or all of various kinds of information produced; and
information transmission means for transmitting said various kinds of information to which said reference data have been added, by broadcast or other communications;

said information receiving device comprising:
information reception means for receiving reference data added information transmitted from said information providing apparatus;
display means for displaying received information;
designating signal reception means for receiving signals for designating information when said information recipient has selected and designated certain information from among said reference data added information; and
data sending means for sending identifying data particular to information selected and designated by said information recipient to said information management apparatus, either directly or via communications means; and

said information management apparatus comprising:
read-out means for reading out information stored in memory means provided externally or internally;
identifying data reception means for receiving identifying data particular to information selected and designated by said information recipient;
data management means for registering and managing said identifying data or reference data added information or reference data or related data in association with said information recipient;
retrieval means for retrieving said identifying data or reference data added information or reference data or related data registered and managed in association with said information recipient and called out by said information recipient accessing and calling out from a communication terminal; and
data sending means for sending said identifying data or reference data added information or reference data or related data that have been retrieved by said retrieval means and read out by said read-out means.

According to the 32nd aspect, an information management system comprises:

an information providing apparatus for transmitting various kinds of information having at least either video information or audio information;

an information receiving device for receiving said various kinds of information;

registration designation means for designating registration of some or all of said various kinds of information received by said information receiving device, provided either integrally with or separately from said information receiving device;

registered information transmission means for transmitting information designated for registration by said registration designation means; and

an information management apparatus for receiving information transmitted by said registered information transmission means, storing and managing that information after associating same with code particular to said information receiving device, with code particular to said registered information transmission means, or with code particular to a person making registration designation, and transmitting said stored and managed information, in whole or in part, to a communications terminal, by calling out information from said communications terminal, on basis of said particular code or code related to that code.

According to the 33rd aspect, an information management system comprises:

an information providing apparatus for transmitting various kinds of information having at least either video information or audio information; an information receiving device for receiving said various kinds of information;

registration designation means for designating registration of some or all of said various kinds of information received by said information receiving device, provided either integrally with or separately from said information receiving device;

registered information transmission means for transmitting identifying data particular to information designated for registration by said registration designation means; and

an information management apparatus for receiving identifying data transmitted by said registered information transmission means, storing and managing those identifying data after associating them with code particular to said information receiving device, with code particular to said registered information transmission means, or with code particular to a person making registration designation, and transmitting information in said stored and managed information that corresponds with said identifying data, to a communications terminal, by calling out information from said communications terminal, on basis of said particular code or code related to that code and said identifying data.

According to the 34th aspect, an information management system comprises:

an information providing apparatus for transmitting various kinds of information having at least either video information or audio information;

an information receiving device for receiving said various kinds of information;

registration designation means for designating registration of some or all of said various kinds of information received by said information receiving device, provided either integrally with or separately from said information receiving device;

registered information transmission means for transmitting identifying data particular to information designated for registration by said registration designation means; and

an information management apparatus for receiving identifying data transmitted by said registered information transmission means, storing and managing information in said various kinds of information corresponding to said identifying data, after associating same with code particular to said information receiving device, with code particular to said registered information transmission means, or with code particular to a person making registration designation, and transmitting said stored and managed information, in whole or in part, to a communications terminal, by calling out information from said communications terminal, on basis of said particular code or code related to that code.

According to the 35th aspect, an information management system comprises:

a broadcast transmitting apparatus for transmitting various kinds of information having at least either video information or audio information;

a television receiver or set top box for receiving said various kinds of information;

registration designation means, provided either integrally with or separate from said television receiver or set top box, for designating registration of some or all of said various kinds of information received by said television receiver or set top box;

registered information transmission means for transmitting information designated for registration by said registration designation means; and

an information management apparatus for receiving information transmitted by said registered information transmission means, storing and managing that information after associating same with code particular to said television receiver or set top box, or with code particular to said registered information transmission means, or with code particular to a person making registration designation, and transmitting said stored and managed information, either in whole or in part, to said communications terminal, by calling out information from said communications terminal on basis of said particular code or code related to that code.

According to the 36th aspect, an information management system comprises:

a broadcast transmitting apparatus for transmitting various kinds of information having at least either video information or audio information;

a television receiver or set top box for receiving said various kinds of information;

registration designation means, provided either integrally with or separate from said television receiver or set top box, for designating registration of some or all of said various kinds of information received by said television receiver or set top box;

registered information transmission means for transmitting identifying data particular to information designated for registration by said registration designation means; and

an information management apparatus for receiving identifying data transmitted by said registered information transmission means, storing and managing those identifying data after associating them with code particular to said television receiver or set top box, or with code particular to said registered information transmission means, or with code particular to a person making registration designation, and transmitting information in said stored and managed information that corresponds with said identifying data to said communications terminal, by calling out information from said communications terminal on basis of said particular code or code related to that code and said identifying data.

According to the 37th aspect, an information management system comprises:

a broadcast transmitting apparatus for transmitting various kinds of information having at least either video information or audio information;

a television receiver or set top box for receiving said various kinds of information;

registration designation means, provided either integrally with or separate from said television receiver or set top box, for designating registration of some or all of said various kinds of information received by said television receiver or set top box;

registered information transmission means for transmitting identifying data particular to information designated for registration by said registration designation means; and

an information management apparatus for receiving identifying data transmitted by said registered information transmission means, storing and managing information in said various kinds of information that corresponds with those identifying data after associating said corresponding information with code particular to said television receiver or set top box, or with code particular to said registered information transmission means, or with code particular to a person making registration designation, and transmitting said stored and managed information, either in whole or in part, to said communications terminal, by calling out information from said communications terminal on basis of said particular code or code related to that code.

According to the 38th aspect, an information providing apparatus used in the information management system described in any one of aspects 32 to 34, comprises:

information production means for producing various kinds of information having at least either video information or audio information;

data editing means for adding reference data constituting detailed information for some or all of said various kinds of information produced; and

information transmission means for transmitting said various kinds is of information to which said reference data were added, by broadcast or other communications.

According to the 39th aspect, a broadcast transmitting apparatus used in the information management system cited in any one of aspects 35 to 37, comprises:

information production means for producing various kinds of information having at least either video information or audio information;

data editing means for adding reference data constituting detailed information for some or all of said various kinds of information produced; and

information transmission means for transmitting said various kinds of information to which said reference data were added, by broadcast or other communications.

According to the 40th aspect, an information receiving device used in the information management system cited in any one of aspects 32 to 34, comprises:

information reception means for receiving various kinds of information transmitted from said information providing apparatus;

display means for displaying received information;

designation signal reception means for receiving signals for designating information out of said various kinds of information when selecting and designating certain information; and

data sending means for sending said selected and designated information to said information management apparatus, either directly or via communications means.

According to the 41st aspect, a television receiver used in the information management system cited in any one of aspects 35 to 37, comprises:

information reception means for receiving various kinds of information transmitted from said broadcast transmitting apparatus;

display means for displaying received information;

designation signal reception means for receiving signals for designating information out of said various kinds of information when selecting and designating certain information; and

data sending means for sending said selected and designated information to said information management apparatus, either directly or via communications means.

According to the 42nd aspect, a set top box used in the information management system cited in any one of aspects 35 to 37, comprises:

information reception means for receiving various kinds of information transmitted from said broadcast transmitting apparatus;

designation signal reception means for receiving signals for designating information out of said various kinds of information when selecting and designating certain information; and

data sending means for sending said selected and designated information to said information management apparatus, either directly or via communications means.

According to the 43rd aspect, an information management apparatus used in the information management system cited in any one of aspects 32 to 37, comprises:

read-out means for reading out information stored in memory means provided externally or internally;

information reception means for receiving information selected and is designated by said information recipient;

data management means for storing and managing said information after associating same with code particular to said information receiving device, or code particular to said registered information transmission means, or code particular to a person making registration designation; and

data transmission means for transmitting said stored and managed information, in whole or in part, to a communications terminal by calling out information from said communications terminal on bases of said particular code or code related to that code.

According to the 44th aspect, an information management system comprises:

an information providing apparatus for transmitting various kinds of information having at least either video information or audio information;

an information receiving device for receiving said various kinds of information;

registration designation means, provided either integrally with or separate from said information receiving device, for designating registration of some or all of said various kinds of information received by said information receiving device;

registered information transmission means for transmitting information designated for registration by said registration designation means; and

an information management apparatus for receiving information transmitted by said registered information transmission means, storing and managing that information after associating same with code particular is to said information receiving device, or with code particular to said registered information transmission means, or with code particular to a person making registration designation, and transmitting said stored and managed information, either in whole or in part, to communications terminal of said person making registration designation, on basis of said particular code or code related to that code, irrespective of whether or not there is an information transmission request.

According to the 45th aspect, an information management system comprises:

an information providing apparatus for transmitting various kinds of information having at least either video information or audio information;

an information receiving device for receiving said various kinds of information;

registration designation means, provided either integrally with or separate from said information receiving device, for designating registration of some or all of said various kinds of information received by said information receiving device;

registered information transmission means for transmitting identifying data particular to information designated for registration by said registration designation means; and

an information management apparatus for receiving identifying data transmitted by said registered information transmission means, storing and managing those identifying data after associating them with code particular to said information receiving device, or with code particular to said registered information transmission means, or with code particular to a person making registration designation, and transmitting said stored and managed information, either in whole or in part, to communications terminal of said person making registration designation, on basis of said particular code or code related to that code, irrespective of whether or not there is an information transmission request.

According to the 46th aspect, an information management system comprises:

an information providing apparatus for transmitting various kinds of information having at least either video information or audio information;

an information receiving device for receiving said various kinds of information;

registration designation means, provided either integrally with or separate from said information receiving device, for designating registration of some or all of said various kinds of information received by said information receiving device;

registered information transmission means for transmitting identifying data particular to information designated for registration by said registration designation means; and

an information management apparatus for receiving identifying data transmitted by said registered information transmission means, storing and managing information in said various kinds of information that corresponds with those identifying data, after associating that information with code particular to said information receiving device, or with code particular to said registered information transmission means, or with code particular to a person making registration designation, and transmitting said stored and managed information, either in whole or in part, to communications terminal of said person making registration designation, on basis of said particular code or code related to that code, irrespective of whether or not there is an information transmission request.

### BRIEF DESCRIPTION OF THE DRAWINGS

FIG. 1 is a simplified block diagram representing the basic conceptual configuration of a data management system according to a first embodiment of the present invention;

FIG. 2 is a block diagram representing an example configuration of an information providing apparatus in the embodiment noted above;

FIG. 3 is a block diagram representing an example configuration of an information receiving device in the embodiment noted above;

FIG. 4 is a block diagram representing another example configuration of an information receiving device in the embodiment noted above;

FIG. 5 is a block diagram representing another example configuration of an information receiving device in the embodiment noted above;

FIG. 6 is a block diagram representing another example configuration of an information receiving device in the embodiment noted above;

FIG. 7 is a block diagram representing an example configuration of an information management apparatus in the embodiment noted above;

FIG. 8 is a conceptual diagram representing classifications of data management techniques in an information management apparatus;

FIG. 9 is a conceptual diagram representing an example of data management with an information management apparatus;

FIG. 10 is a conceptual diagram representing an example of data management with an information management apparatus;

FIG. 11 is a block diagram representing another example configuration of an information receiving device in the first embodiment;

FIG. 12 is a conceptual diagram of a data specifying method when identifying data are not used; and

FIG. 13 is a conceptual diagram of another example of a data specifying method when identifying data are not used.

### DESCRIPTION OF THE PREFERRED EMBODIMENTS

### Embodiment 1

A first embodiment of the present invention is now described with reference to the drawings.

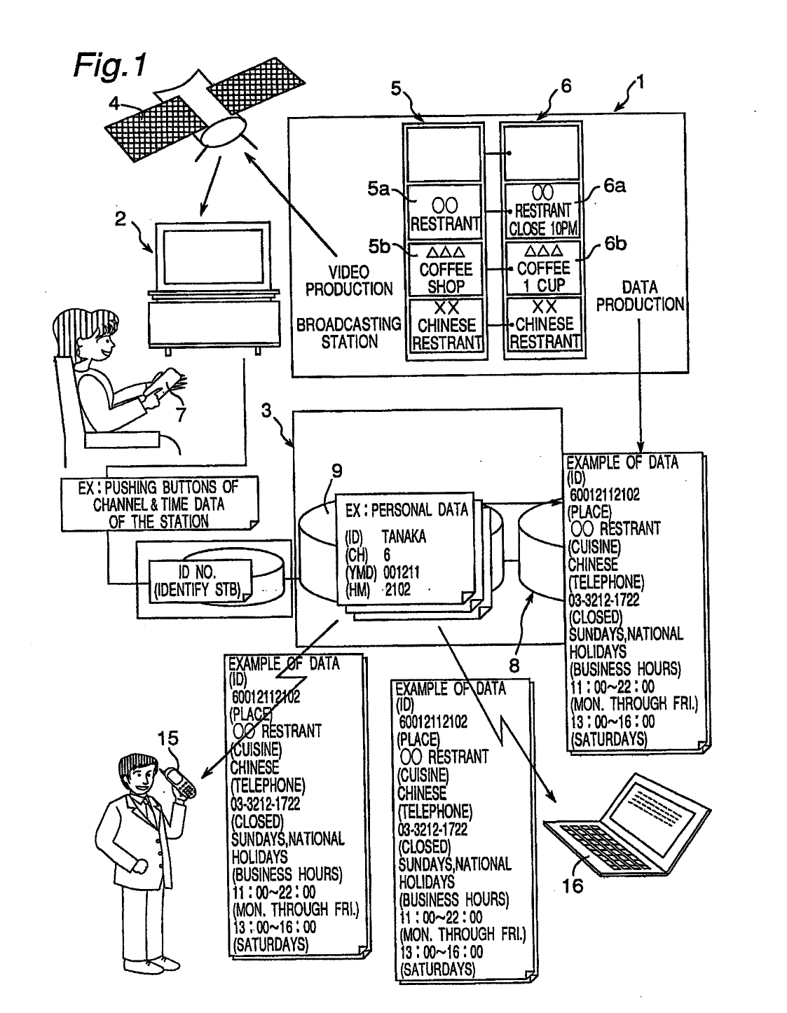

FIG. 1 is a simplified block diagram representing the basic conceptual configuration of a data management system according to the first embodiment of the present invention. This diagram roughly diagrams the processes whereby, to program information, reference data that are data which provide guides to or introduce the content thereof are added, to the entirety of that program information or for every information unit that is a part thereof (i.e. to each of a series of multiple frames), and produced as broadcast data by a broadcast station that is the information provider, those broadcast data are broadcast from the broadcast station, and those reference data noted above, or related data that are related to the content of the reference data, whether making the reference data more detailed or not more detailed, are managed.

In FIG. 1, item 1 represents one example of the broadcast equipment installed at a broadcast station, that is, the information providing apparatus, and of program information (various kinds of information) produced and broadcast by this broadcast station.

Item 2 indicates an information broadcast receiver terminal device that is the information receiving equipment placed at the location of the viewer who is the information recipient. This information broadcast receiver terminal device 2 is ordinarily a television receiver which can receive digital broadcasts and which is also a multiple function broadcast receiver.

Item 3 indicates an information management apparatus (information management apparatus) which is operated by the information manager, has a database of broadcast information, and performs management tasks relating thereto. The program broadcasting is done by a BS broadcast or CS broadcast using such network facilities as a broadcast satellite 4, or, alternatively, by a digital broadcast that uses land-based digital signals.

The information providing apparatus 1 of the broadcast station, as one example, produces and broadcasts the program information 5. This program information 5 represents a restaurant guide program, with 5a being a video introducing a restaurant, 5b being a video introducing a coffee shop, and so forth, so that information is displayed in the form of the names and interior videos or exterior videos of various kinds of food service establishment.

Then, for these kinds of information, reference data 6 are produced. These reference data 6 are information required by a user in order to visit the establishment, or information meant to make the user want to visit the establishment, such as, depending on the respective store (5a, 5b, etc.), specialties or menu items, business opening and closing hours, addresses, telephone numbers, and so forth, which are displayed by text information (or possibly by photographs, audio, or videos) as indicated in 6a and 6b. These reference data 6 are broadcast or transmitted together with the program information 5.

Also, depending on the case, coupon information is sometimes added to provide discounts or free gifts to viewers who see the program and visit the establishment. Also, depending on the case, specific identifying data (such as serial numbers) are attached beforehand to each of these reference data 6. These reference data 6 are broadcast or transmitted together with the program information 5 from the information providing apparatus 1 to the information broadcast receiver terminal 2.

Also, there are cases where information is sent from the information providing apparatus 1 to the information management apparatus 3, but, in such cases, all kinds of modes are possible. In terms of the sending means, to begin with, sending means based on broadcasts or communications are permissible, or information possessed by the information providing apparatus 1 may be recorded on an information recording medium such as an optical disk, and that information recording medium passed to the information management apparatus 3.

As to the information sent, moreover, that may be identifying data only, or program information with added reference data, or reference data. Alternatively, related data separate from the reference data (including information that explains the reference data in greater detail or information related to the reference data even if it is not more detailed, or other related data such as musical data, video data, or electronic data, etc.) may be sent. However, such sending of information to the information management apparatus 3 is not necessarily limited to information sent from the information providing apparatus 1, and provision may be made so that information is managed by other external equipment and sent therefrom.

The program information 5 and reference data 6 diagrammed in FIG. 1 represent videos in model form, furthermore, and rather than adding reference data 6 to only one frame of the program information 5, it is preferable that the same reference data 6 be added to each of a series of multiple frames of the program information 5.

The broadcast receiver terminal device 2 is configured by a multimedia terminal device, and comprises both reception functions for receiving databases other than the broadcast information, and transmission functions for sending necessary information over a communication line. It also has functions for receiving data inputs from a remote controller 7 (or 51 as noted subsequently) operated by the viewer.

The information management apparatus 3 has a database 8 wherein are stored broadcast program data (reference data or related data) sent from the information providing apparatus 1 or external equipment, and these pieces of information are managed in association with identifying data particular to each piece of information. However, it is not absolutely necessary that the information management apparatus 3 have this database 8, and the information providing apparatus 1 or external equipment may manage the database 8 instead, for example.

The information management apparatus 3 is provided with a personal database 9, moreover, configured such that identifying data particular to information selected and designated by viewers are registered and managed in association with those viewers, or the designated information itself (reference data, or program information with added reference data, or related data) is registered and managed in association with those viewers.

This information management apparatus 3 is capable of access via a communication line, moreover, reference data or related data can be transmitted based on data registered in the personal database 9, and transmission commands can be issued to external equipment or the like.

The information recipient can access the information management apparatus 3 using a communication terminal such as a portable telephone 15 or personal computer 16, and can freely call up information (reference data and related data) managed by the database 8, based on identifying data registered in his or her own personal database 9. A minimum of two databases are required in this data management system. Those are, specifically, the personal database 9 wherein are stored personal interests and preferences, and the database 8 for the reference and related information prepared by the contents provider. Thus services can be provided even without the database 8 being in the possession of a service provider in operating the service and, further, the volume occupied by personal database 9 can be decreased. In order to connect these two separated databases, however, associating data are necessary, and those associating data are called identifying data. These identifying data may be serial numbers, or, in the case of television, may be defined by a time and channel. The databases contain these identifying data, basic key words to facilitate efficient searches, and the reference data and related data. There are three types of mutual holding of these data by the respective databases.

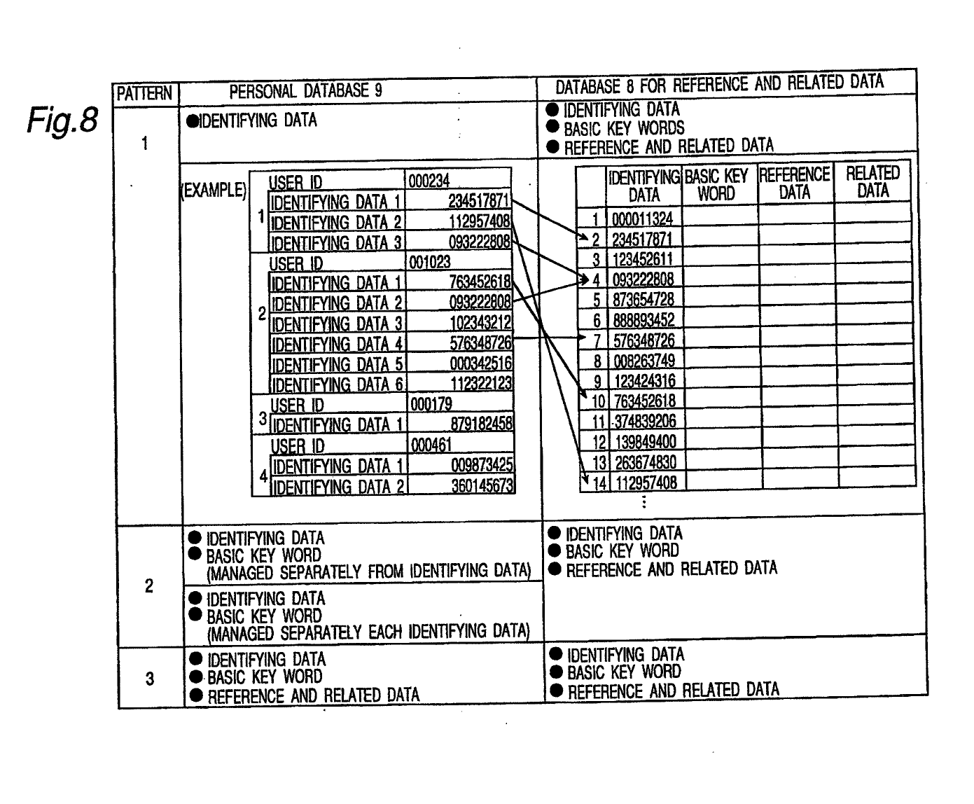

These are diagrammed in FIG. 8. In the case of pattern 1, only identifying data are registered in the personal database 9, while in the database 8 are registered basic key words, reference data, and related data for each item of identifying data. One example is indicated here for the personal database 9 and the database 8. In the personal database 9 are stored identifying data registered in the past according to user IDs assigned in individual user units. The person having the user ID 00234, for example, has made three registrations in the past, and the identifying data therefore are 234517871, 112957408, and 093222808. In the database 8, meanwhile, basic key words, reference data, and related data (data such as text information, still picture information, video, and audio) are stored for each item of identifying data.

By having data organized in the two databases in this way with at least the identifying data as criteria, it is possible for each user, as a result, to access registered information. A benefit in this case is that, because the data are made very compact in the personal database 9, management and storage is possible using comparatively small servers and memory units even when the number of service members increases.

In the case of pattern 2, identifying data and basic key words are registered in the personal database 9. This may be done in two ways, that is, the basic key words may be managed for each item of identifying data, or they may be made into a database irrespective of the identifying data. What are here called basic key words are necessary in order for users to conveniently retrieve information, as will be described subsequently. In cases where basic key words are included in the identifying data, retrieval is made simpler when making retrievals, but the total volume of data increases.

Conversely, when the basic key words are made into a database separately from the identifying data, while the data volume can be kept lower, the retrieval means become intricate. In the case of pattern 3, on the other hand, the identifying data, basic key words, reference data, and related data are all managed individual by individual, wherefore, when making registrations, the relevant related data are extracted from the database 8 and registered.

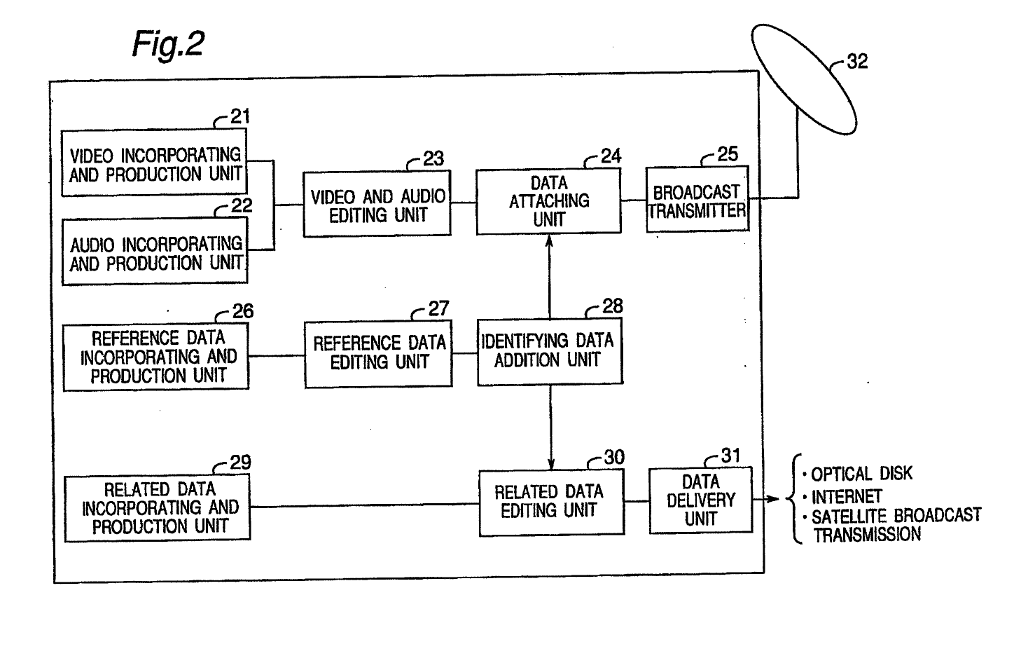

FIG. 2 is a block diagram representing an example configuration of the information providing apparatus 1 relating to this embodiment.

In FIG. 2, item 21 is a video incorporating and production unit configured such that live video photographed with a camera or analog or digital video materials recorded on video tape or the like are incorporated and supplemented with various kinds of effects and the like.

Item 22 is an audio incorporating and production unit configured such that live audio recorded with a microphone or analog or digital audio materials recorded on audio tape or the like are incorporated and supplemented with various kinds of effects and the like.

Item 23 is a video and audio editing unit capable of editing by rearranging the video and audio materials in a time sequence.

Item 24 is a data attaching unit for performing the operation of adding reference data to those video and audio materials.

And item 25 is a broadcast transmitter for transmitting series of contents after converting them to data suitable for broadcasting.

Item 26 is a reference data incorporating and production unit for incorporating text information and still pictures, etc., constituting data materials for data broadcasting, and making keyboard inputs.

Item 27 is a reference data editing unit for editing those materials so that they may be viewed on a television screen.

Item 28 is an identifying data addition unit for adding identifying data to both the reference data and related data. (The identifying data addition unit is not required in cases where peculiar identifying data are added only to the reference data of individuals, using instead the broadcast date and time (reception time) and broadcast channel (reception channel) as identifying data to specify the reference data.)

Item 29 is a related data incorporating and production unit for incorporating related information materials and information that is more detailed than the reference data sent out by broadcast, and making keyboard inputs.

Item 30 is a related data editing unit for editing those materials so that they can be viewed on the screen of a personal computer or portable telephone.

Item 31 is a data delivery unit for delivering data edited with the related data editing unit by various kinds of media such as optical disk or by internet or satellite broadcast means.

And item 32 is an antenna for transmitting broadcasts from the information providing apparatus 2.

This FIG. 2 represents an example of an information providing apparatus 2 characterized in that it has the identifying data addition unit 28 for adding identifying data to the reference data and related data when conducting ordinary television broadcasting. The identifying data addition unit 28 adds identifying data both to the reference data sent out by television broadcast and to the related data that users will access subsequently by personal computer or portable telephone. In this way it becomes possible in the broadcast to make associations with data in which a user is interested, making it possible to access those data later by personal computer or portable telephone. The portion relating to the related data here may be in a unit external to the information providing apparatus 2.

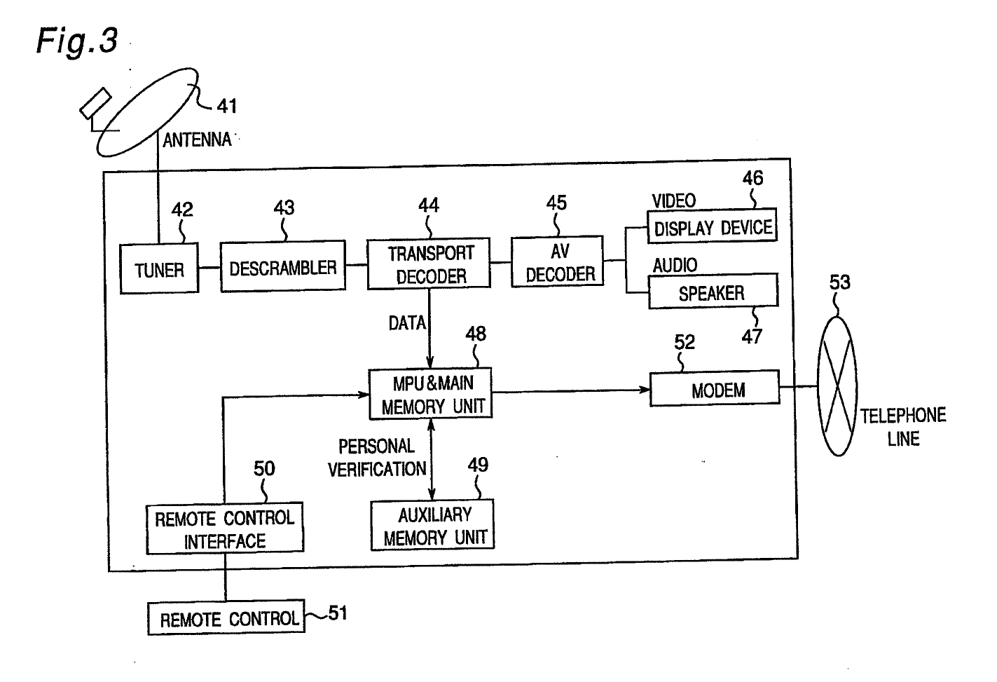

FIG. 3 is a block diagram representing an example configuration of the information broadcast receiver terminal device 2 that functions as an information receiving apparatus for receiving program information or reference data or the like broadcast from the information providing apparatus 1, which is in the possession of the viewer.

For this information broadcast receiver terminal device 2, something like a television is used that is connected to a communication line and has communications functions.

In FIG. 3, item 41 is an antenna which receives broadcasts from the information providing apparatus 2.

Item 42 is a tuner that receives signals of designated frequencies and performs demodulation processing and error correction and the like.

Item 43 is a descrambler that decodes encoded information.

Item 44 is a transport decoder that extracts data multiplexed in video and audio signals and sends extracted data (here referring to identifying data and reference data) to an MPU. Designated video and audio data are also output to an AV decoder.

Item 45 is an AV decoder which expands compressed video and audio data and sends the video and audio, respectively, to output devices.

Item 46 is a display unit for displaying video, while item 47 is a speaker for outputting audio.

Item 48 is an MPU & main memory unit which assembles and transmits necessary data by “triggers” input by an input device such as a remote control.

Item 49 is an auxiliary memory unit that here stores individual verification data (code) of the television owner (information recipient).

Item 51 is a remote controller (remote) by which the viewer controls the television. This remote control 51 sends instruction signals to the MPU & main memory unit 48 via a remote control interface 50.

This FIG. 3 represents an example of an information receiver device that is used in cases where various kinds of information (information wherein reference data are added to video and audio data) sent from the information providing apparatus 1 in a condition wherein specific identifying data are added to individual pieces of reference data beforehand. These various kinds of information having such identifying data attached are received by the antenna 41.

The received signals are passed through a descrambler 43, have the identifying data and reference data extracted by a transport decoder 44, and are passed to the MPU & main memory unit 48. Meanwhile, the broadcast content is passed through the AV decoder 45 and broadcast from the display device 46 and speaker 47, making it possible for the viewer to view and listen to the same. The viewer, while watching the video, operates the remote control 51 at will to display reference data constituting detailed information on the display device. When this is done, if the reference data interests the viewer, the viewer operates the remote control 51 to designate registration. The signal for this registration designation is sent through the remote control interface 50 to the MPU & main memory unit 48. The MPU & main memory unit 48, upon receiving the registration designating signal, defines specific identifying data for the reference data being broadcast at that time, and sends those together is with the individual verification data stored in the auxiliary memory unit 49 to the information management apparatus 3 via a modem 52 and telephone line 53.

Here the remote control was used as means for designating registration, but this is not limited to something separate from the information providing apparatus, and a controlling unit may be provided integrally with the information providing apparatus and registration designations made thereby.

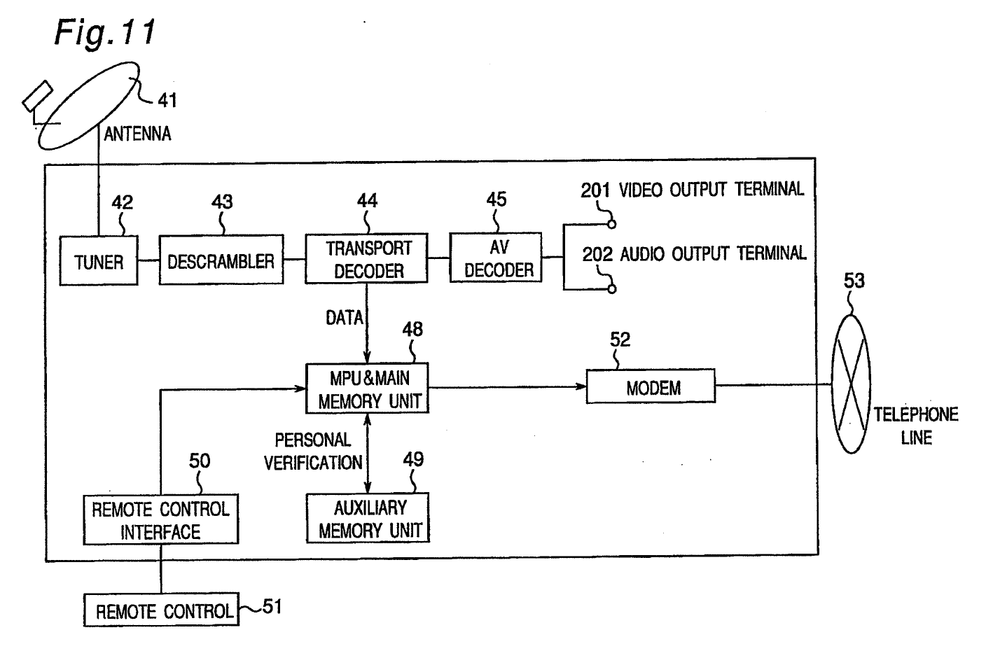

In the description above, moreover, a television receiver is given as an example of an information receiving device, but such is not limited thereto, and a set top box (STB) may also be used. In that case, the display device will not be in the information receiving device but will be provided separately. The configuration in a case where an STB is used as the information receiving device is diagrammed in FIG. 11. No further description is given for configuring elements that are the same as those in FIG. 3. What is different from the configuration diagrammed in FIG. 3 is that there is no display device 46 or speaker 47, but a video output terminal 201 and audio output terminal 202 are provided instead, with the display device and speaker being provided separately and externally. The configuration in other respects is the same as that diagrammed in FIG. 3.

As to the timing wherewith the information receiving device sends identifying data to the information management apparatus, there are a number of modes, based on the time that the information recipient (viewer) designated registration, or on a time at which a certain period of time has elapsed since the registration designation, or at a certain point in time after the registration designation. The number of registration is designations is not limited to one, moreover, and provision may be made to transmit only when the registration designating operation has been performed a certain number (plural number) of times, for example. It is also permissible, for the personal verification data, to use particular codes that have been provided in the television, STB, or other information receiving device, or particular codes may be used in the registration designation means (remote, portable telephone, PHS, etc.). Or the telephone number itself or a particular code corresponding to the telephone number may be used.

Or, alternatively, a code that was newly established for the information recipient when such service use was first started may be used.

As to the method of transmitting the personal verification data, furthermore, the personal verification data may be registered beforehand in the television receiver or STB, so that they may be called up in association with registration designating operations and transmitted to the information receiving device, or, alternatively, personal verification data may be input to the registration designation means by the information recipient at the time of registration designation, and transmitted to the information receiving device.

As another alternative, instead of the personal verification data being actively transmitted from the information recipient end, provision may be made so that the information receiving device that received the identifying data specifies a telephone number using a number display function or the like, so that that information can be used as the personal verification data for the information recipient.

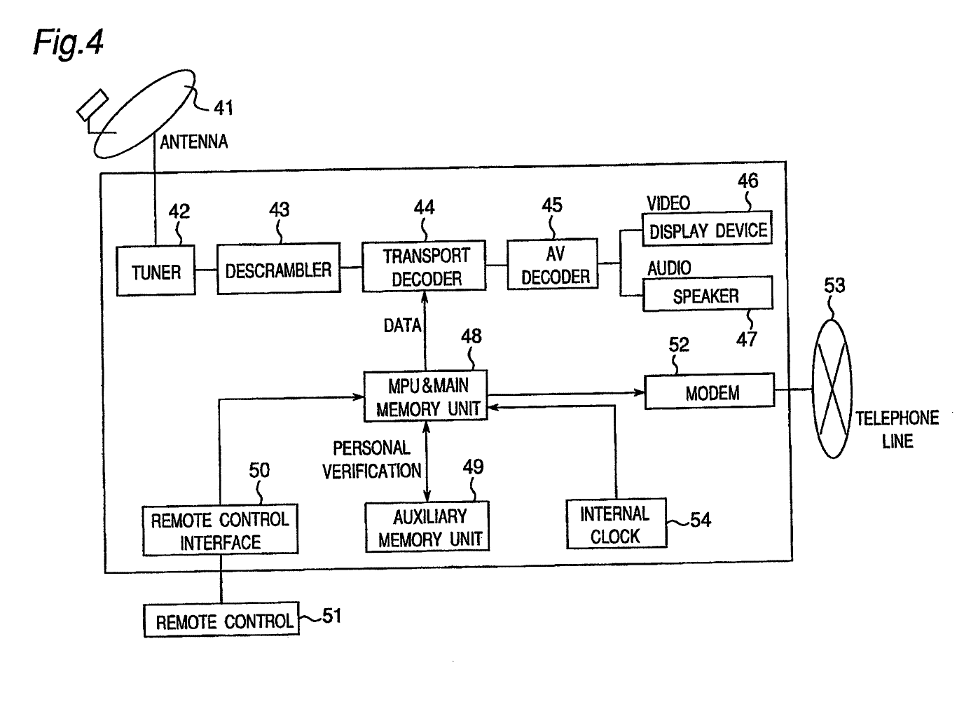

FIG. 4 represents an example of an information receiving device that is used when particular identifying data are not added to the individual reference data, in the various kinds of information (information wherein reference data has been added to video and audio data) sent from the information providing apparatus 1, but, instead, reference data are defined using the broadcast date and time (reception time) and broadcast channel (reception channel) as the identifying data. This differs from FIG. 3 in that an internal clock 54 is here provided which counts years, months, days, hours, and minutes.

In other respects this is the same as FIG. 3, wherefore no further description is given. In this example also, when there are reference data that interest the viewer, and the remote control 51 is manipulated to designate registration, this registration designation signal is sent via the remote control interface 50 to the MPU & main memory unit 48. Also, when the viewer has manipulated the remote control 51 to designate a channel beforehand, the MPU & main memory unit 48 receives and stores a signal specifying the channel. The MPU & main memory unit 48, upon receiving a registration designation signal, sends a signal identifying the pre-stored channel, the time (year, month, day, hour, and minute) indicated by the internal clock 54, and the personal verification data stored in the auxiliary memory unit 49 all together to the information management apparatus 3 via the modem 52 and the telephone line 53.

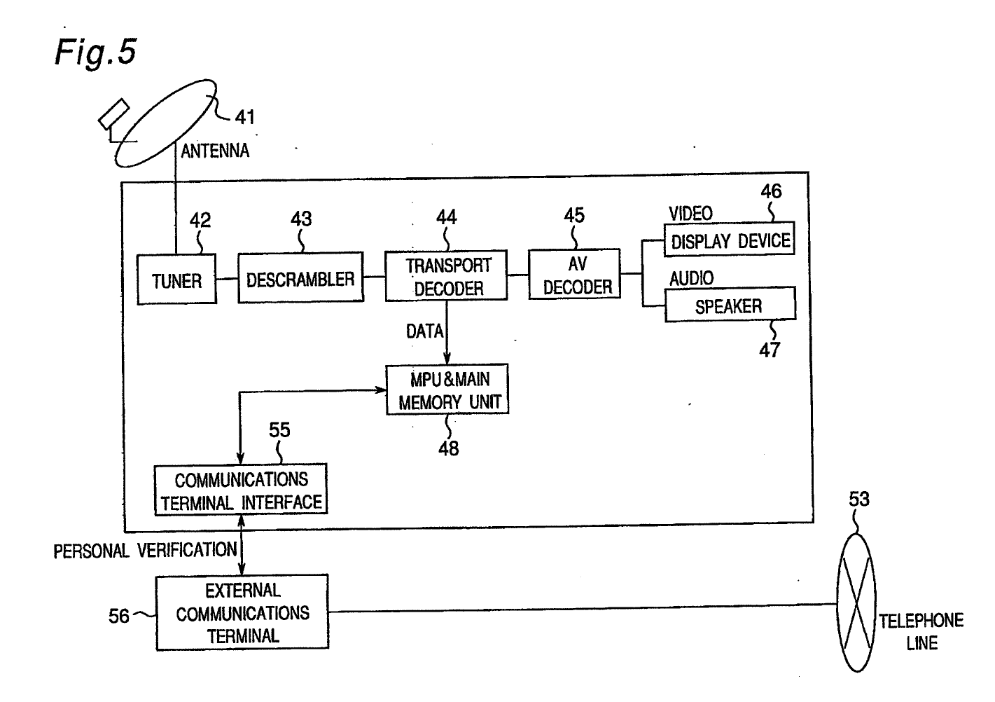

FIG. 5 represents an example of an information receiving device used when the registration designation is made not by operating the remote control 51, but rather by operating an external communications terminal 56 such as a portable telephone, for example.

There are two points of difference here with FIG. 3, namely that the external communications terminal 56 is used for the registration designation, and that a communications terminal interface 55 is provided which makes it possible to pass data back and forth in both directions with the external communications terminal 56. By these means, personal verification can be done using the external communications terminal 56 (using the portable telephone number, for example), without using auxiliary memory, and it is also possible to transmit identifying data using a telephone line connected to that external communications terminal 56 (which will be described subsequently), without using the modem 52, wherefore neither the auxiliary memory 49 nor the modem 52 is needed. In most other respects this is the same as FIG. 3, so no further description is given here.

In this example also, when there are reference data of interest to the viewer, and registration designation is made by operating the external communications terminal 56, the signal for that registration designation is sent to the MPU & main memory unit 48 via the communications terminal interface 55. The MPU & main memory unit 48, upon receiving the registration designation signal, transmits the identifying data to the external communications terminal 56 via the communications terminal interface 55. The external communications terminal 56, thereupon, transmits those identifying data together with the personal verification data over the telephone line 53 to the information management apparatus 3.

Those personal verification data may be registered in the MPU & main memory unit 48, and transmitted together with the identifying data to the external communications terminal 56, or they may be registered beforehand in the external communications terminal 56, and then transmitted by the external communications terminal 56 to the information management apparatus 3 together with the registered personal verification data when the identifying data are received thereby.

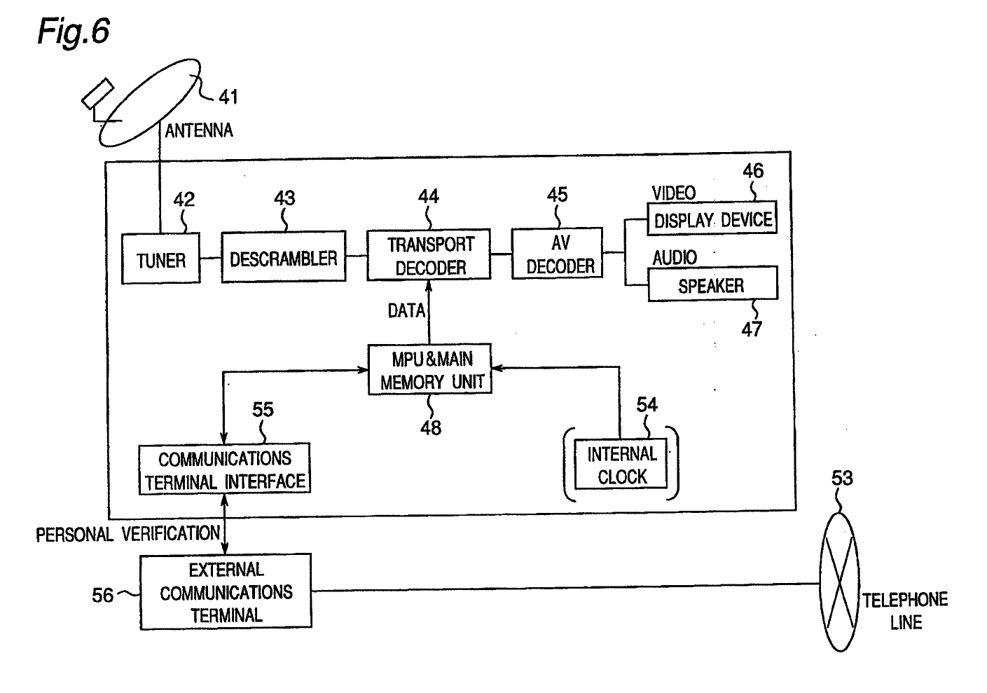

FIG. 6 represents an example of an information receiving device that is used in cases where registration designation is performed by operating the external communications terminal 56, and particular identifying data are not added to the individual reference data, in the various kinds of information (information wherein reference data have been added to video and audio data) sent from the information providing apparatus 1, but, instead, reference data are defined using the broadcast date and time (reception time) and broadcast channel (reception channel) as the identifying data.

This differs from FIG. 5 in that an internal clock 54 is here provided which counts years, months, days, hours, and minutes. In other respects this is the same as FIG. 5, wherefore no further description is given. In this example also, when there are reference data that interest the viewer, and the external communications terminal 56 is manipulated to designate registration, this registration designation signal is sent via the communications terminal interface 55 to the MPU & main memory unit 48.

Also, when the viewer has manipulated the external communications terminal 56 to designate a channel beforehand, the MPU & main memory unit 48 receives and stores a signal specifying the channel. The MPU & main memory unit 48, upon receiving a registration designation signal, sends a signal identifying the pre-stored channel and the time (year, month, day, hour, and minute) indicated by the internal clock 54 to the external communications terminal 56, and the external communications terminal 56 transmits that signal together with the personal verification data held to the information management apparatus 3 via the telephone line 53. The internal clock 54 here need not be in that information receiving device, and, if an internal clock that counts year, months, days, hours, and minutes is provided in the external communications terminal 56, the information here may be used and transmitted.

Thus, when a portable telephone or other communications terminal is used as the remote controller 51, that portable telephone or the like is given sending and receiving functions that use infrared light or the like, and information designating signals are sent by these infrared light transmissions to the information broadcast receiver terminal device 2. Thereupon, the identifying data for the information designated by the information broadcast receiver terminal device 2 is sent back to the portable telephone or the like, the portable telephone that received those identifying data calls up the information management apparatus 3, and the identifying data and personal verification data for the information designated are sent from the portable telephone to the personal database 9 of the data management apparatus 3 and registered therein.

In cases where the external communications terminal has channel switching functions and an internal clock, furthermore, the external communications terminal will have its own channel information and time information, wherefore there will not necessarily be a need to conduct communications with the information receiving device when performing a registration designation operation, but provision may be made so that, when a registration designation operation is conducted with the external communications terminal, the channel information and time information already held are transmitted to the information management apparatus. In cases where the external communications terminal has channel switching functions but no internal clock, on the other hand, provision may be made so that only the time information is received from the information receiving device. And in cases where the external communications terminal has an internal clock but no channel switching functions, provision may be made so that only the channel information is received from the information receiving device. Thus, by using a portable telephone or the like as the remote controller, even when at the home of someone else, or during an outing somewhere, if one views the screen of an information broadcast receiver terminal device in the possession of someone else and finds video (information) thereon which one wishes to register, it will be possible to designate and register that information using one's own portable telephone or the like.

The remote control 51 may have a user ID set therein so that it can only be used by one user, or the user IDs of multiple users may be set so that a plurality of users such as family members can make use thereof. The remote control 51 may be provided with separate personal operating buttons such as a father button, a mother button, and a child button, for example, so that data registration designations are made to the information management apparatus 3 by depressing those personal buttons, that is, to the personal database 9 of the person designated by the respective button. Thus data management can be performed separately for different individuals even when the information broadcast receiver terminal device 2 is commonly used in the family.

In such cases, however, the personal verification data are registered in association with the individual buttons, beforehand, either in one or other of the remote control 51 and the information broadcast receiver terminal device 2, or in both, so that, when a button is depressed, the personal verification data corresponding with that button and the identifying data particular to the data designated for registration by the viewer are transmitted to the personal database 9.

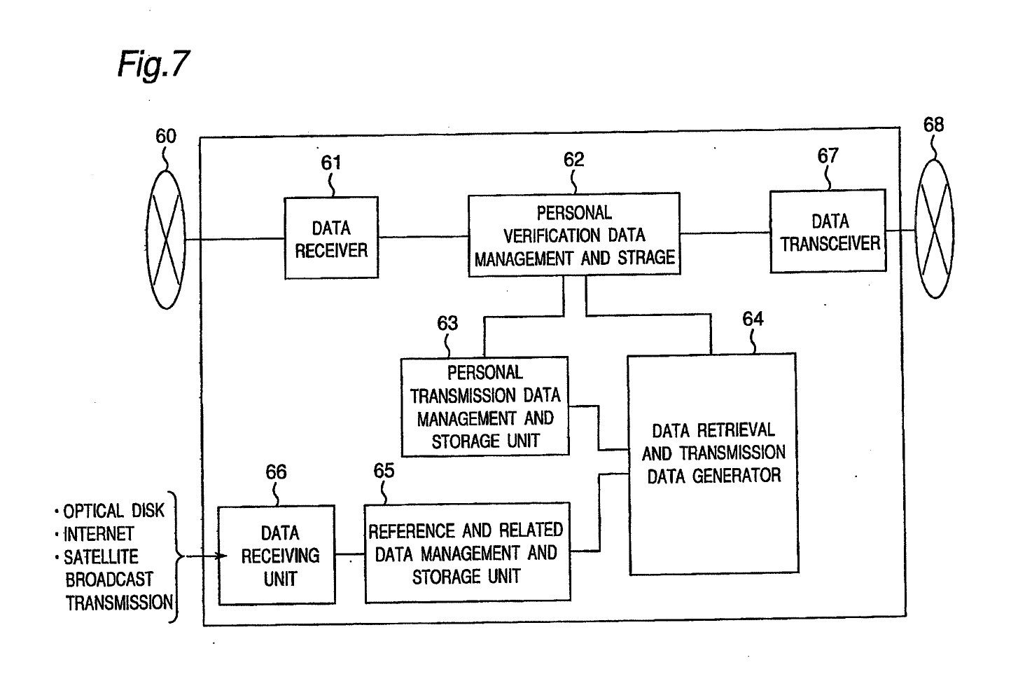

FIG. 7 is a block diagram that represents an example configuration for the information management apparatus 3 relating to this embodiment. In FIG. 7, item 60 is a telephone line, 61 is a data receiver for receiving identifying data transmitted from the information broadcast receiver terminal device 2, 62 is a personal verification data management and storage unit for storing and managing personal verification data (that is, IDs) for individuals making access from the outside, 63 is a personal transmission data management and storage unit that is a so-called personal database, wherein basic key words or identifying data for different individuals, or, in some cases, reference data and related data are also stored and managed. Item 64 is a data retrieval and transmission data generator that compares identifying data and reference data (or related data) and searches for reference data (or related data) by key word. And item 65 is a reference and related data management and storage unit that has so-called database functions and that stores and manages reference data and related data in association with particular identifying data.

Item 66 is a receiving unit for receiving reference data or related data from the information providing apparatus 1 or from an external device. Many different modes are possible here, in terms of how the receiving is done, such as satellite broadcast signal broadcast receiving, or communications by internet, or deliveries received by a recording medium such as an optical disk. The reference and related data management and storage unit 65 and the receiving unit 66 may be inside the information management apparatus 3, as diagrammed in FIG. 7, or they may be installed somewhere else, such as inside the information is providing apparatus 1 or in another external device. Item 67 is a data transceiver wherewith an information recipient who has made access using a communications terminal sends and receives data, and 68 is a communication line, such as a public telephone line, a data communication line, a portable telephone line that supports digital communications such as a PHS, or a communications network such as the internet.

The information management apparatus 3 may be installed under the administration of the information provider (broadcast station) noted earlier or, alternatively, it may be installed under the administration of an information manager separate from the information provider. In the former case, the information provider and the information manager are the same entity, whereas in the later case the information provider and the information manager are separate entities.

The operation of a database management system relating to this embodiment, having such a configuration as described in the foregoing, is now described. In the information providing apparatus 1 of the broadcast station, the program information 5 comprising various kinds of information is produced in the video and audio editing unit 23. Alternatively, program information produced externally is available. Examples of such program information produced include, in addition to the cooking guide program described earlier with reference to FIG. 1, programs belonging to a variety of genres such as travelogue programs, drama programs, foreign film programs, etc. Included in the “program” concept, of course, are commercials. To some of this program information, reference data 6 are added in the data attaching unit 24. Depending on the case, moreover, coupon information for giving discounts to viewers who view the program and visit the establishment may also be added in the data attaching unit 24. As an example of a case where reference data are added into the program information, the cooking guide program is illustrated in FIG. 1, but there are other programs such as the following, for example. (1) Travelogue Program Case: The program information 5 (contents) are produced with video information portraying domestic or foreign scenic views and with narration information describing the localities. The reference data 6 that are attached thereto include such things as locality explanations, transportation means, famous scenic spots, lodging information, and local specialty products. (2) Drama or Foreign Film Program Case: The reference data 6 added might be shopping information on the apparel or shoes, etc., worn by the persons appearing in the program, or explanations of the filming locations, etc., in information units of the various scenes that come out in the program, that is, of the various kinds of information.

Also, identifying codes such as program numbers are attached to the programs, and particular identifying data are added to the reference data 6. The information providing apparatus 1 then sends the produced program data to the information broadcast receiver terminal device 2 and the information management apparatus 3 using either broadcast means or prescribed communications means.

With the information broadcast receiver terminal device 2 that receives the program data, in terms of normal operations, the viewer controls an EPG screen displayed on the display device 46, searches for a program (or, alternatively, operates a remote controller to switch channels), and selects a program he or she wishes to see. Then, if the is program has been determined, operation inputs are made to display that program, and the video is displayed on the display device 46. Then, when the video is being viewed, in a program or scene containing added reference data 6, a reference data added mark indicating the presence of reference data is displayed on the display device 46. In programs or scenes to which no reference data 6 have been added, such reference data added mark is not displayed. When the viewer is interested in the guide content for a scene in which the reference data added mark is displayed, he or she depresses a prescribed button on the remote control 51 in order to register the data as his or her own, and sends a command signal to the information broadcast receiver terminal device 2. This command signal is sent to the MPU & main memory unit 48 via the remote control interface 50, whereupon the MPU & main memory unit 48 interprets this as being a command used for data management, and sends such information as the program identifying data for the program designated for registration and the identifying data of the reference data, together with the personal verification data for that customer, to the information management apparatus 3, using the public telephone line 53.

There are also cases where no reference data added mark is used. In such cases, by depressing a prescribed button on the remote, for example, a mark is displayed on the screen or a voice notification is made only when reference data 6 are available.

This information broadcast receiver terminal device 2 can also store broadcast data received in a disk drive (not shown), and can fetch those data to a secondary memory device (not shown). Then, when a viewer watches a program and registers reference data, that may be program playback data stored in the disk drive or secondary memory device.

The information management apparatus 3 receives the program data from the information providing apparatus 1 with the data receiving unit 66. In the information management apparatus 3, program information 5 and reference data 6 (and also related data) are stored and controlled in the reference and related data management and storage unit 65 in order to be managed. This reference and related data management and storage unit 65 creates the database 8 by storing all kinds of programs.

There is no absolute necessity, however, that this database reside in the information management apparatus 3, and it may instead reside in the information providing apparatus 1 or in another external device. In such cases, the information management apparatus 3 only manages the identifying data, or, alternatively, only the identifying data and the basic key words, becoming a relay point for calling up information every time an access and call are made from a communications terminal, and transmits signals to the information providing apparatus 1 or other external device instructing them to transmit information to the communications terminal (or information management apparatus). The identifying data sent from the information broadcast receiver terminal device 2 to the information management apparatus 3 are received in the data receiver 61, and then, after personal verification has been received by the personal verification data management and storage unit 62, sent to the personal transmission data management and storage unit 63 and there managed.

The information managed by the personal transmission data management and storage unit 63 may be only identifying data, or identifying data and minimally necessary basic key words, or, alternatively, the selected information itself, that is, the reference data or related data, or video or other information added thereto.

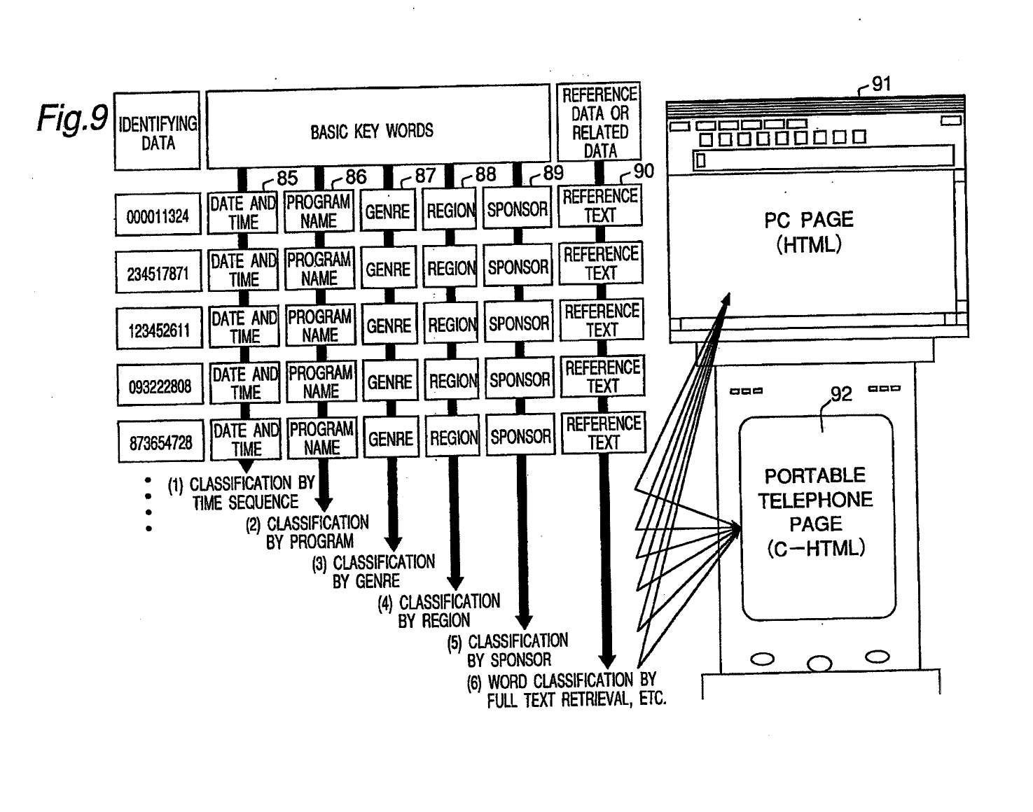

An example of information retrieval with such an information management apparatus 3 is represented in FIG. 9. The basic key word classifications are made five, namely “date and time 85, “program name” 86, “genre” 87, “region” 88, and “sponsor” 89, for example. It is assumed that basic key words corresponding to such classifications are already contained in all of the reference data and/or related data. At this time, data which one has registered with the remote, etc., in the past can be lined up according to the broadcast time therefor using the basic key words classified in “date and time” 85. Similarly, data can be lined up in the same way by each classification, that is, by the “program name” 86 broadcast at that time, by the “genre” 87 that the information belongs to (whether a coffee shop, travel information, or cultural knowledge, for example), by the “region” 88 that the information belongs to (the address if a store, or the locality of origin if news, for example), and finally, by the “sponsor” 89 of that product. In addition to the basic key words, it is also possible to extract frequently used words by making full-text retrieval of reference text 90 of reference data or related data. By lining up by such key words, it becomes possible to easily and quickly pull out data registered unconsciously by the user. It becomes possible at such times to first display data of frequent server registration, or first display data of high access frequency, in basic key word units.

Such basic key words are added in order to eventually arrive at wanted information, following the user's memory, but in order to actually show information in a hierarchical manner, it is necessary to generate files written in languages matching the terminals (browsers) when pulling in information from a number of communications terminals (examples being page 91 written in HTML for personal computers, and page 92 written in C-HTML for portable telephones). In order to do that, according to the respective classification method, there is the method of creating particular menu screens for each user beforehand, and the method of automatically generating such screens at retrieval time. In the case of creating such screens beforehand, when the information management apparatus 3 has received identifying data, for example, basic key words are extracted form the reference data or related data specified by those identifying data, the classification into which the identifying data received should belong on the basis of those basic key words is found and assigned, and the file is created or updated. In order to effect automatic generation, on the other hand, retrieval is performed using the basic key words based on the identifying data, and the results are displayed.

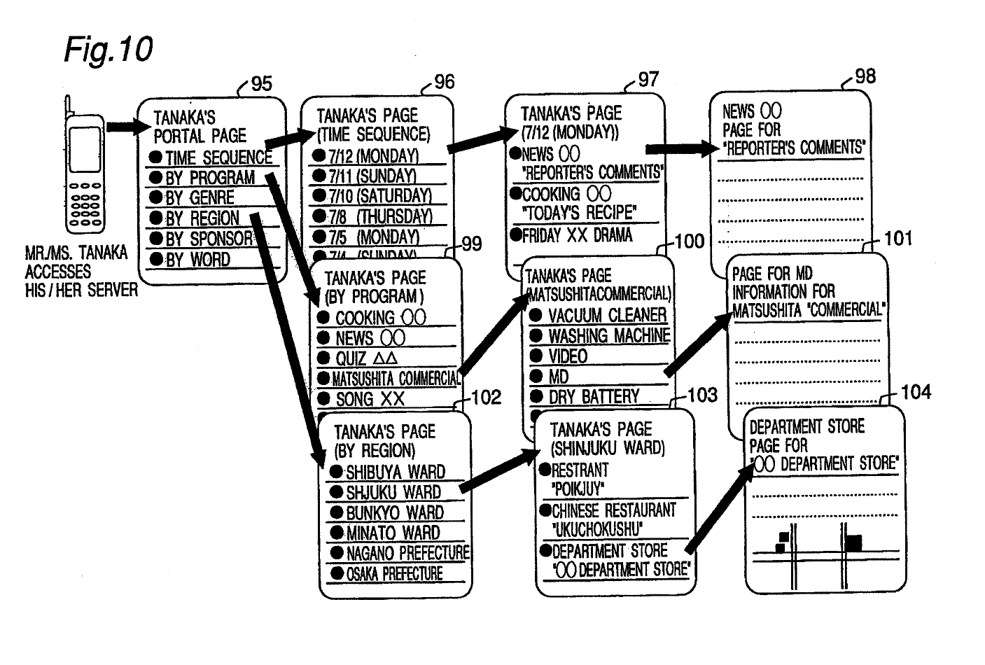

FIG. 10 diagrams what kind of screen images a user actually navigates through in order to arrive at the wanted information. When first making access by personal computer or portable telephone, after receiving verification of the person's identity, entry is first made from a portal page 95 unique to each user. What is diagrammed in FIG. 10 are images associated with accessing with a portable telephone. First, screen 95, the “portal page” for Mr./Ms. Tanaka, is entered. When a time sequence therein is selected, the screen 96 is entered, which contains data whereon Mr./Ms. Tanaka made registrations in the past, displayed in order from the most recent date. When July 12 (Monday) is selected here, screen 97 is entered whereon are displayed the names of programs and information broadcast and registered on July 12 (Monday). When “such and such news” is selected here, the screen 98 can be navigated to, whereon will be displayed the information seen once before on television, or more is detailed related information.

Similarly, information can be retrieved, by program as in pages 99 to 101, and by region as in pages 102 to 104. As to other retrieval methods, there is the method wherewith the user inputs retrieval key words, and retrieves and displays information that matches or contains those key words. Concerning pages 98, 101, and 104, these may be reference data or related data, or a link may simply be provided to a company advertising page, or these may be a shopping mall or reservation system or other site providing information that fluctuates in real time. The example diagrammed in FIG. 10 is a portable telephone display. With a personal computer, however, pages may be created which also employ still pictures or audio data, and the way the display is done may be changed depending on the terminal. With a personal computer, CPU performance is usually very good, and the screen size is also large, making it possible to create easier to view screens combining large files such as files containing large volumes of more detailed information, or video, audio, or still picture files.

It is also possible to paste banner advertisements on the “portal page” 95, for example. Because this will always be the first page entered when one million members of this service have been gathered, for example, it can become the portal site that will definitely be first accessed by one million persons. In these banner advertisements, it is also possible to present advertisements matched with personal preferences surmised from a personal information database. By creating a personal information database such as noted above, moreover, it is possible to send out direct mail or push-type advertisements matched with that person's preferences. Conventionally, advertising modes on television are evaluated on the basis of program viewer ratings. With this method, however, it is possible to find out more directly whether or not individuals are interested, and the standard of evaluation can be made the number of data accumulations or access frequency. As an example of identifying data utilization, when identifying data are passed back and forth among users by word of mouth, or identifying data are exchanged and sent between the server areas of users, it is easy to exchange information on stores or products that are booming, and to mutually confirmation meeting locations.

When a request to send data is made from the communications terminal of a customer that is the information recipient to the information management apparatus 3 conducting such data management as this, that request is received by the data transceiver 67, and the content thereof is sent to the data retrieval and transmission data generator 64 after the personal verification has been received by the personal verification data management and storage unit 62. For the personal verifications, the personal verification data (particular code) sent from the information receiving device when registration was made may be used as is, or, alternatively, data related to those personal verification data may be used. In the data retrieval and transmission data generator 64, reference data and related data are retrieved, using the retrieval method described in FIG. 9 and FIG. 10, and sent to the communications terminal of the customer.

Various devices can become communications terminals, such as portable telephones (including PHS), personal computers, navigation terminals used in automobile navigation systems and the like, or television receivers (which may be the information broadcast receiver terminal device 2 of this application, for example) or game devices equipped with communications functions. In particular, when a navigation terminal or PHS is used, a method of use such as that described below is possible. The information management apparatus 3, when identifying data, or information including reference data, or reference data, or related data are registered and stored in the personal database, also registers and stores information indicating the region in addition to those types of information. Then, by accessing the personal database in the information management apparatus 3 by a navigation terminal or PHS, information on the current location where the navigation terminal or PHS is being held (i.e. positional information indicated by an artificial satellite or the like) is compared against the region indicating information registered and stored in the personal database. If these two sets of information match or the locations are proximate within a certain distance, the information stored in the personal database is automatically displayed on the navigation terminal or PHS. Thereby, if the personal database is accessed from an automobile navigation terminal while an automobile or the like is being driven, information on the region currently being moved through can be obtained automatically without any particular information retrieval operation being effected.

Accordingly, as diagrammed in FIG. 1, when a customer, while moving along the street, wishes to obtain information on a restaurant or other commercial establishment concerning which he or she previously found interesting while viewing the information broadcast receiver terminal device 2 and for which he or she registered reference data, if he or she calls up the data management apparatus 3 from the portable telephone 15 that is the communications terminal in his or her possession and requests that the reference data 6 be sent, the targeted reference data 6 will be sent to the portable telephone 15, wherefore he or she can find the targeted commercial establishment without losing his or her way, and, in addition to that, when a coupon is attached to the reference data 6, can enjoy the benefits thereof. Furthermore, when a customer, while preparing information or written document, wishes similarly to obtain information on a store concerning which he or she previously found interesting while viewing the information broadcast receiver terminal device 2 and for which he or she registered reference data, in order to incorporate shopping information as guide information into that document, if he or she calls up the information management apparatus 3 from the personal computer 16 that is the communications terminal in his or her possession and requests that the reference data 6 be sent, the targeted reference data 6 will be sent to the personal computer 16, wherefore he or she can type in the content of those data from the keyboard, or insert the guide document sent as is into the document being prepared. Thus he or she can quickly obtain sure information and increase the speed of document preparation.

Similarly, moreover, if various kinds of statistical data that have been displayed in a news program or the like are registered, they can be very useful in preparing materials for meetings. Furthermore, by providing information desired for dissemination that is original data (digital data) such as music, video, or information broadcast on television as a series of related data, and having a viewer register it, the dissemination service for the music or video in which there is interest can be received on a later date, either with or without charge. Thus data featuring higher picture and sound quality can be obtained than is possible merely by recording a television or other broadcast. A mode such as that described below is possible as the method of disseminating such related data. The example described here is one where digital musical data are disseminated as related data for a charge. If an information recipient makes control inputs to designate registration when a favorite musical piece is being broadcast on a television music program, for example, the related data (digital musical data) are considered to be provisionally registered, without being immediately registered, and only certain extracted information (such as title, performing artist, classification, number of songs, price, etc.) is registered. The information recipient, on a later date, calls up that extracted information using a communications terminal, and, when wishing to again obtain the related data, makes a request from the communications terminal to the information management apparatus that the related data be sent. In cases where the related data are provided at a charge, when the request is made, information for making settlement electronically (credit card number or ID number linked thereto, etc.) is sent together therewith from the information recipient to the information management apparatus, whereupon electronic settlement is performed and the digital musical data are sent to the information recipient. By such method as this, the information recipient, when purchasing music or other digital data as related data for a charge, there is no need to make an immediate decision at the time of the registration designation while viewing the television, but the extracted information alone can be registered and the purchasing procedures taken care of on a later date. Thus there is no danger of purchasing data for which there is a charge in error simply by the initial registration operation, and the information recipient can perform the registration designation without worry.

The information broadcast receiver terminal device 2 described in the foregoing is not limited to a television receiver, and may instead be a radio receiver. In that case, however, while there is no need to receive and display video, it is nevertheless necessary that the radio receiver be equipped with functions for receiving and displaying test data such as text broadcasts. Thus the display of reference data is also possible with radio, and it is possible for the recipient to select and designate information. Nor is this limited to a method whereby the information recipient accesses the information management apparatus from a communications terminal and calls up information, and it is permissible to provide so-called push-type services wherewith information is actively and continuously transmitted from the information management apparatus to the communications terminal of the information recipient irrespective of whether or not there is a request for information to be sent. In such cases as that, when data are registered in the information management apparatus, for example, the registered information is transmitted regularly by a mail service on a later date from the information management apparatus to the communications terminal of the information recipient. Alternatively, information on the contents of the registered information may be sent by the mail service, without sending the registered information itself, thus notifying the information recipient of the registration status.

### Embodiment 2

In the invention described in the foregoing, a system is described wherein information is sent using broadcast means or other communications means, and information identifying data are sent from a receiving terminal device receiving that information, thereby performing data management and sending reference data when necessary. There is no limitation to such a system as that, however, and reference data can be managed by some other system.

In other words, information magazines, catalogs, pamphlets, or direct mail printed materials, and various kinds of information that include reference data, and individual information identifying information are printed and the printed materials are distributed. Meanwhile, data of the various kinds of printed information noted above (electronic data) are sent from the information provider to the information manager by prescribed communications means, and data of the various kinds of information including added reference data that was sent to the information manager as noted above are stored and managed by the information manager. Then, when a customer who has obtained such printed materials becomes interested in the content of guides related to printed reference data, he or she operates communications means such as a portable telephone or personal computer in order to register those as his or her own identifying data, calls up the data management apparatus, and registers the identifying data. In terms of ways in which the identifying data may be registered, there is for example the method of the user seeing a code number noted in the printed material and then inputting that with the portable telephone or personal computer. There is also the method whereby a bar code is printed in the printed material, the portable telephone or the like is equipped with a bar code reader, and the bar code is read with that bar code reader. There is also the method of reading in using photographic equipment, wherein the portable telephone or the like is equipped with a CCD image sensor or camera, and these codes are read in. There is furthermore the method whereby the information recipient makes a voice input to the portable telephone, and that voice is converted to data and transmitted.

In convention halls where events are held, moreover, code numbers are printed in pamphlets provided at the convention hall, and provision is made so that identifying data can be transmitted by the same procedures as those used with the printed materials described in the foregoing. Another method which can be adopted is one wherein weak radio signals carrying identifying codes are propagated inside the event convention hall, the data carried by those weak radio signals are received by the portable telephone of an information recipient in the convention hall, and needed information is designated and transmitted to the personal database 9.

The subsequent operations for requesting reference data and data transmission operations relating thereto are the same as in the first embodiment described earlier. The way in which data are managed in the information management apparatus 3 is also the same as in the first embodiment described earlier.

### Embodiment 3

In the first embodiment described earlier, moreover, provision is made so that, with a registration designation operation, identifying data and personal verification data are transmitted from an information receiving device to an information management apparatus. In another example, however, the information designated by the information recipient for registration (video information, audio information, text information, graphic information, etc., or any combination thereof) may itself be transmitted to the information management apparatus, together with the personal verification data, without using identifying data. The points of difference between this embodiment and the first embodiment described is earlier are now described.

Firstly, in this case, there is no need for program information or reference data and the like to be sent beforehand from the information providing apparatus 1 at the broadcast station to the information management apparatus 3. The reason therefore is that, by the information recipient making the registration designation, the program information and reference data will be transmitted to the information management apparatus from the information receiving device. However, because the related data have content that differs from the content broadcast, those data must be received separately by the information management apparatus 3, stored, and managed. In that sense, in the configuration of the information management apparatus diagrammed in FIG. 7, the data receiving unit 66 and reference and related data management and storage unit 65 will be used only for receiving, storing, and managing the related data.

In the configuration diagrammed in FIG. 7, moreover, the data receiver 61 is not for receiving identifying data, but will receive raw information designated for registration. The management performed by the information management apparatus, furthermore, will not manage the identifying data, but will manage the raw information for each piece of personal verification data. Looking at the configuration of the information providing apparatus 1, in the configuration diagrammed in FIG. 1, the identifying data addition unit 28 will become unnecessary, and the data delivery unit 31 will only need to have functions for delivering related data.

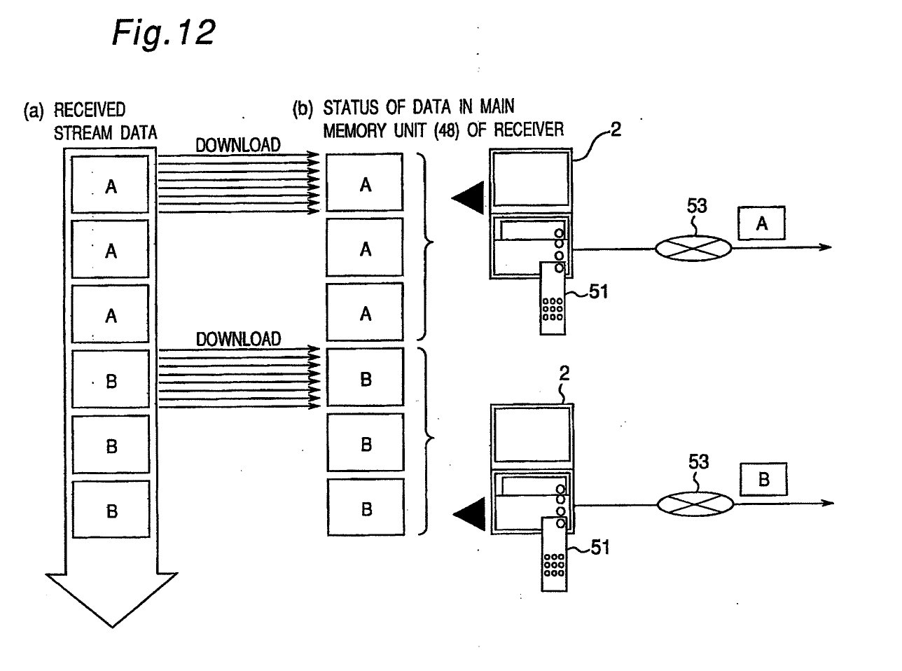

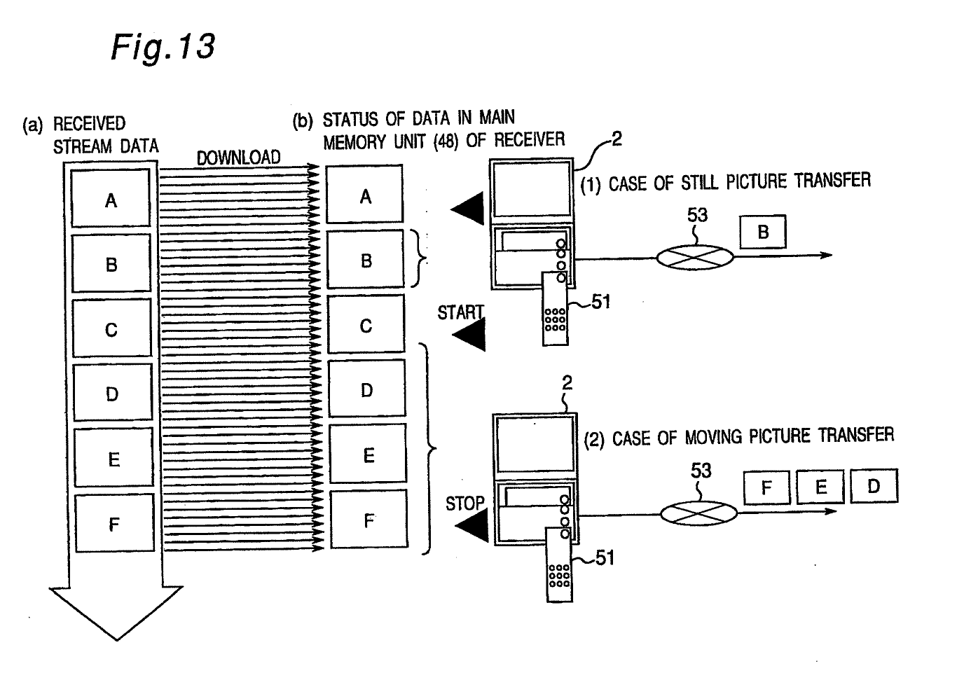

The method of designating program information for registration in the information receiving device will also become different. This is described using FIG. 12 and FIG. 13.

FIG. 12 is a conceptual diagram of a method for designating data information such as text or graphic information for registration. In FIG. 12, the large downward pointing arrow indicated in (a) represents stream data received by the information broadcast receiver terminal device 2. In this diagram, the lower down data are indicated, the later those data flow chronologically. In the case diagrammed here, data “B” flows following data “A.” These data flow at the back of the program video being normally broadcast, for example, and correspond to the reference data that appear on the screen in response to an instruction input from a viewer.

These stream data are received by the antenna 41 of the information receiving device diagrammed in FIG. 3, for example, and will pass through the tuner 42, descrambler 43, transport decoder 44, and AV decoder 45 to be displayed on the display device 46.

At (b) in FIG. 12 is diagrammed the status of data in the MPU & main memory unit 48 of the information receiving device. Here in (b), as in (a), chronologically later conditions are indicated the lower down one goes.

The operation is now described on the basis of FIG. 12. The stream data received will be subject to changes in data content according to the broadcast content. Normally, while a series of content is being broadcast, in terms of the stream data also, the same data A are transmitted repeatedly. When the content of the stream data changes from A to B, the MPU & main memory unit 48 detects header information indicating that the content of the stream data has become new, whereupon new stream data B are downloaded from the transport decoder 44 and stored in main memory. The MPU & main memory unit 48 maintains the memory content in the main memory until it detects the next header information. When it detects the next header information, it reads out and stores new data.

Meanwhile, when an information recipient looking at the information receiving device 2 performs an operation with the remote control 51 to designate registration, the data stored in the MPU & main memory unit 48 when the registration designation signal was received by the information receiving device 2 are read out, and those data are sent over the communications line 53 to the information management apparatus.

FIG. 13 is a conceptual diagram of a method for designating video and audio information for registration. What is in common therein with FIG. 12 is not further described here, and only what differs is described. At (a) in FIG. 13 are diagrammed the video and audio stream data. In the case of video and audio, the content changes from A to B to C to D to E to F and so on as time elapses, wherefore, unlike in the case diagrammed in FIG. 12, the MPU & main memory unit 48 will continually download the video and audio data flowing through the transport decoder 44 and store those data in the main memory unit. In other words, the status of the data in the main memory unit will be changing from moment to moment.

Meanwhile, when an information recipient looking at the information receiving device 2 performs an operation with the remote control 51 to designate registration, the data stored in the MPU & main memory unit 48 associated with the receipt of the registration designation signal by the information receiving device 2 are read out, and those data are sent over the communications line 53 to the information management apparatus.

When transferring still pictures, for example, the registration is designation is made with a single manipulation of the remote control 51. More specifically, the still picture transfer mode is selected with the remote control 51, and the frame “B” following next after the frame “A” running when the registration designation button was depressed is read out from the main memory unit and transferred.

When moving pictures are being transferred, on the other hand, the moving picture transfer mode is selected with the remote control 51, and, by depressing the registration designation button twice, the first piece and last piece of data that one wishes to send are specified. The frame data “D” next after the frame “C” that is flowing when the registration designation button was depressed the first time is read out from the main memory unit and the transfer begins. Everything from there up to the frame “F” flowing when the registration designation button was depressed the second time is read out from the main memory unit and transferred. Alternatively, provision may be made so that the registration designation button is only depressed once. Then frames will be transferred from the frame next after the frame flowing at that time of registration designation up to a frame that is a predetermined prescribed number of frames later (or frames will be transferred that flow until a predetermined prescribed time period has elapsed).

In this manner the information recipient makes registration designations to specify information, and, without using identifying data, the information itself that was designated for registration is transmitted to the information management apparatus. In cases where raw information is transmitted from the information receiving device 2 to the information management apparatus 3, the volume of data will become larger than when identifying data are transmitted, wherefore the capacity required in the line used for the transmission will have to be larger than in the case of the first embodiment.

With respect to other points, various embodying modes will be possible as with the first embodiment. Thus, while there are points of some difference from the first embodiment, in this embodiment also it is possible for information in which an information recipient is interested to be registered, stored, and managed in a simple manner, and to call out that information easily on a later date using a communications terminal, thereby affording the same benefits as the first embodiment.

### BENEFITS OF INVENTION

Based on the present invention, as described in the foregoing, an information recipient (or an information recipient) can register information such as that provided by television, radio, magazine or other printed materials, or event convention halls, etc., on his or her own server (information management apparatus) with ease, and can easily call out that registered information using any of various types of communications terminal.

In cases where various kinds of information are selectively designated, in particular, it is only necessary to associate identifying data particular to the selected information with an individual person and send them to an information management apparatus, wherefore loads on communication lines are light, and implementation is easily possible using home telephone lines.

Based on the present invention, furthermore, information indicating the preferences and interests of viewers will be collected in the information management apparatus, wherefore such information can be used also in market analysis. Various benefits are realized. For example, is by collating and analyzing transmissions of identifying data and requests and calls for various kinds of information made by information recipients, it is possible to present guidelines for information provider program production, or to use the data in marketing for sponsors. It is also possible to conduct research to determine what kinds of programs should be presented in different time slots, what kinds of commercials should be used for which programs, and what time slot provides the best programs for a sponsor, etc.

What is claimed is:

1. A data management method, comprising:
providing a plurality of information units, each information unit being a part of a base information and carrying information representing one of various items in said base information, said base information being provided to an information recipient by a unidirectional communication system from an information provider;
generating, by a first communications device which is associated with an information recipient, an information recipient verification data that identifies the information recipient and an identifying data that identifies the information unit selected by the information recipient,
receiving, at an information manager from the first communications device, the information recipient verification data and the identifying data that identifies the information unit selected by the information recipient;
storing in a first database the identifying data and the information recipient verification data in a linked manner, when the information manager receives the identifying data and the information recipient verification data;
storing in a second database the identifying data and a reference data in a linked manner, said reference data defining features of the information unit corresponding;
sending the information recipient verification data from a second communications device to the information manager; and
accessing from the second communications device to the first database to find the information recipient verification data and the linked identifying data, and further accessing from the first database to the second database to find the corresponding identifying data and the linked reference data, whereby the second communications device is able to receive the linked reference data.

2. The data management method of claim 1, wherein the information unit from the information provider is received at the first communications device.

3. The data management method of claim 1,
wherein the information recipient verification data and the identifying data are received from the first communications device based on a signal received from a remote controller generated when the information recipient selects the information unit, and
wherein the remote controller comprises a plurality of information designating buttons for separate individuals, each information designating button corresponding to a different information recipient verification data.

4. The data management method of claim 1,
wherein the information unit is received by and presented to the information recipient using an information unit receiving device, and
wherein a portable controller is used to select the information unit.

5. The data management method of claim 1,
wherein the information recipient verification data comprises one of a personal identification that uniquely identifies an individual information recipient, and a group identification that identifies a group of associated individual information recipients.

6. The data management method of claim 1,
wherein the identifying data comprises at least one of a time when the information recipient selects the information unit, and a channel by which the information recipient receives the information unit.

7. The data management method of claim 1,
wherein the identifying data comprises codes which identify the selected information unit, the codes being applied to the information unit prior to the information unit being provided to the information recipient.

8. The data management method of claim 1,
wherein the reference data comprises at least one of detailed information which describes the selected information unit and detailed information which describes a subject of the selected information unit.

9. The data management method of claim 1,
wherein the reference data comprises at least one of date indicating information which indicates a date when the information unit is selected, a program indicating information which indicates an identity of the selected information unit as a media program, a program genre indicating information which indicates a genre of the selected information unit, a region indicating information which indicates a region in which the selected information unit is selected, and a sponsor indicating information which identifies a sponsor of the selected information unit.

10. The data management method of claim 1,
wherein the reference data comprises at least one of date indicating information, program indicating information, program genre indicating information, region indicating information, and sponsor indicating information,
wherein at least one of the date indicating information, the program indicating information, the program genre indicating information, the region indicating information, and the sponsor indicating information is retrieved by the second communications device as at least one retrieval key using the information manager, and
wherein the at least one retrieved retrieval key is displayed on the second communications device in order based on frequency of usage.

11. The data management method of claim 1,
wherein the information unit comprises at least one of audio information and video information.

12. The data management method of claim 1,
wherein the information unit comprises information included in printed material.

13. The data management method of claim 1,
wherein the information unit comprises at least one of broadcast information, aired information, and information disclosed at an event.

14. The data management method of claim 1,
wherein the information recipient verification data and the identifying data are stored in the first database by an apparatus external to the information manager.

15. The data management method of claim 1,
wherein the reference data is stored in the second database by an apparatus external to the information manager.

16. The data management method of claim 1,
wherein the reference data is added to the information unit prior to the information unit being selected by the information recipient.

17. The data management method of claim 1,
wherein the information manager calls at least one of the information unit and the reference data upon receiving the information recipient verification data and the identifying data, the called at least one of the information unit and the reference data being stored in a database in association with the information recipient verification data.

18. The data management method of claim 1, further comprising:
receiving the information unit at the information manager; and
storing the information unit in a database by the information manager.

19. The data management method of claim 1,
receiving the information unit at the information manager,
wherein the information unit is stored in a database by an apparatus external to the information manager.

20. The data management method of claim 1,
wherein the information recipient receives the information unit using at least one of a set top box and a television receiver.

21. The data management method of claim 1,
wherein the information recipient verification data comprises one of a code particular to an information unit receiving device, a code particular to an identifying data transmission device, and a code particular to the information recipient who selects the information unit.

22. A data management system, comprising:
an arrangement which provides a plurality of information units, each information unit being a part of a base information and carrying information representing one of various items in said base information, said base information being provided to an information recipient by a unidirectional communication system from an information provider;
a first communications device which is associated with an information recipient and generates an information recipient verification data that identifies the information recipient and an identifying data that identifies the information unit selected by the information recipient;
an information manager which receives from the first communications device the information recipient verification data and the identifying data;
a first database which stores the identifying data and the information recipient verification data in a linked manner, when the information manager receives the identifying data and the information recipient verification data;
a second database which stores the identifying data and a reference data in a linked manner, said reference data defining features of the information unit;
a second communications device which sends the information recipient verification data to the information manager; and
a controller which controls accessing from the second communications device to the first database to find the information recipient verification data and the linked identifying data, and further accessing from the first database to the second database to find the corresponding identifying data and the linked reference data, whereby the second communications device is able to receive the linked reference data.
